(19) United States
(12) Patent Application Publication
(10) Pub. No.: US 2023/0288846 A1
(43) Pub. Date: Sep. 14, 2023

(54) IMAGE FORMING APPARATUS

(71) Applicant: CANON KABUSHIKI KAISHA, Tokyo (JP)

(72) Inventor: KEISUKE ISHIZUMI, Kanagawa (JP)

(21) Appl. No.: 18/119,965

(22) Filed: Mar. 10, 2023

(30) Foreign Application Priority Data
Mar. 11, 2022 (JP) 2022-037940

(51) Int. Cl. G03G 15/16; G03G 15/00

(52) U.S. Cl. CPC G03G 15/1675; G03G 15/556; G03G 15/1605; G03G 2215/1614

(57) ABSTRACT

An image forming apparatus includes a photosensitive member, a charging member, an exposing unit, a developing member, an intermediary transfer member and a voltage applying portion. A controller controls a primary transfer contrast which is a difference between a transfer voltage applied by the voltage applying portion in a nip and a potential of a part exposed by the exposing unit on the photosensitive member. By applying the transfer voltage to the intermediary transfer member, the controller transfers the toner image from the photosensitive member to the intermediary transfer member by flowing a current in a circumferential direction. The controller controls the primary transfer contrast by controlling the transfer voltage based on information on a usage state of toner related to a number of printed sheets. The controller controls so that the transfer voltage becomes lower as the number of printed sheets is larger.

### FIELD OF THE INVENTION AND RELATED ART

The present invention relates to an image forming apparatus such as a laser printer, copy machine, and a facsimile with an electrophotographic method.

Conventionally, an image forming apparatus including a structure which uses an intermediary transfer member is well-known. This image forming apparatus transfers a toner image formed on a surface of a photosensitive drum onto a primary transfer member provided in a portion (a first transfer portion) facing the photosensitive drum by applying a voltage (hereinafter, referred to as a primary transfer) in a primary transfer process. Further, as repeating the primary transfer process with toners of several colors, multi-colored toner images are formed on a surface of the intermediary transfer member. In a secondary transfer process multi-colored toner images formed on the surface of the intermediary transfer member are collectively transferred onto a surface of a recording material such as a sheet of paper by applying a voltage on a secondary transfer member (hereinafter, referred to as a secondary transfer). The toner image transferred on the surface of the recording material such as a sheet of paper is fixed on the recording material by a fixing means and then the multi-colored image is formed. For example, a technique of forming a low resistance conductive layer inside of a peripheral surface of a base layer of an intermediary transfer belt and applying a primary transfer voltage as electric current flows from electric current supplying member of the primary transfer which is provided in an area where is not right underneath of the photosensitive drum to a circumferential direction of the intermediary transfer belt in order to improve transferring is disclosed in Japanese Laid-Open Patent Application No. 2018-036624. Also, for example, a technique of adjusting the primary transfer voltage according to a rate of deteriorated toner is disclosed in Japanese Laid-Open Patent Application No. 2012-150137.

In a structure using the intermediary transfer belt including a conventional inside conductive layer an electric potential inside of the intermediary transfer belt tends to be substantially constant. Thus, there is a case even an upstream portion of a rotational direction of the intermediary transfer belt with respect to a primary transfer nip portion where is a contact point of the photosensitive drum and the intermediary transfer belt has a potential that is close to the primary transfer voltage. Therefore, it is possible to occur discharging current at the upstream of the primary transfer nip portion with respect to the rotational direction of the intermediary transfer belt and it makes possible to occur a pre-transfer which the toner formed on the photosensitive drum before the primary transfer has transferred before reaching the primary transfer nip portion. The pre-transfer tends to occur especially when the charging amount of the toner is low.

Further, with the conventional technique that determines the primary transfer voltage depending on a detected result of degree of the toner deterioration, the primary transfer voltage must be determined with considering a balance of not only the pre-transfer but the malfunction of the primary transfer because of shortage of primary transfer current. To determine the primary transfer voltage with considering the balance of the pre-transfer and the malfunction of the primary transfer, it is necessary to configure a primary transfer contrast comprising of a potential on the photosensitive drum and the primary transfer voltage. Thus, it is required even for the image forming apparatus with the intermediary transfer belt including the low resistance inside layer to obtain an excellent performance of the primary transfer.

### SUMMARY OF THE INVENTION

The present invention is developed in a situation described above. The object of this invention is to obtain an excellent performance of the primary transfer even when the image forming apparatus with the intermediary transfer belt including the low resistance inside layer is used.

To solve the problem as described above, the present invention provides as follows:

(1) an image forming apparatus for forming an image on a recording material, the image forming apparatus comprising: a photosensitive member; a charging member configured to charge the photosensitive member; an exposing unit configured to form an electrostatic latent image by exposing the photosensitive member depending on an image signal; a developing member configured to form a toner image by developing the electrostatic latent image with the toner; an intermediary transfer member provided with a first layer having conductivity and a second layer having conductivity and a lower resistance value than that of the second layer, and to which the toner image is transferred in a nip portion between itself and the photosensitive member; a voltage applying portion configured to apply a transfer voltage to the intermediary transfer member; and a control portion configured to control a primary transfer contrast which is a difference between the transfer voltage applied by the voltage applying portion in the nip portion and a potential of a part exposed by the exposing unit on the photosensitive member, wherein, by applying the transfer voltage to the intermediary transfer member from the voltage applying portion, the control portion transfers the toner image from the photosensitive member to the intermediary transfer member by flowing a current in a circumferential direction, wherein the control portion controls the primary transfer contrast by controlling the transfer voltage based on information on a usage state of the toner related to a number of printed sheets of the recording material, and wherein the control portion controls so that the transfer voltage becomes lower as the number of printed sheets is larger.

(2) an image forming apparatus for forming an image on a recording material, the image forming apparatus comprising: a photosensitive member; a charging member configured to charge the photosensitive member; an exposing unit configured to form an electrostatic latent image by exposing the photosensitive member depending on an image signal; a rotary provided with a plurality of developing devices each including a developing member configured to form a toner image by developing the electrostatic latent image with the toner by contacting the photosensitive member and an accommodating portion configured to accommodate the toner, and configured to be capable of switching the developing member to be contacted to the photosensitive member by rotating; an intermediary transfer member provided with a first layer having conductivity and a second layer having conductivity and a lower resistance value than that of the second layer, and to which the toner image is transferred in a nip portion between itself and the photosensitive member; a voltage applying portion configured to apply a transfer voltage to the intermediary transfer member; and a control portion configured to control a primary transfer contrast which is a difference between the transfer voltage applied by the voltage applying portion in the nip portion and a potential of a part exposed by the exposing unit on the photosensitive member, wherein, by applying the transfer voltage to the intermediary transfer member from the voltage applying portion, the control portion transfers the toner image from the photosensitive member to the intermediary transfer member by flowing a current in a circumferential direction, wherein the control portion controls the primary transfer contrast by controlling the transfer voltage based on information on a usage state of the toner related to a number of printed sheets of the recording material, and wherein the control portion controls so that the transfer voltage becomes lower as the number of printed sheets is larger.

Further features of the present invention will become apparent from the following description of exemplary embodiments with reference to the attached drawings.

### BRIEF DESCRIPTION OF THE DRAWINGS

FIG. 1 is a cross-sectional schematic view explaining a structure of an image forming apparatus in embodiments 1 and 2.

FIG. 2 is a schematic view explaining a control block of the image forming apparatus in the embodiments 1 and 2.

Part (a) and part (b) of FIG. 3 are a schematic view showing of a structure of a vicinity of a primary transfer nip portion and a cross-sectional schematic view of a structure of an intermediary transfer belt in the embodiments 1 and 2.

FIG. 4 is a schematic view showing a potential state of an inner conductive layer in the embodiments 1 and 2.

Part (a) and part (b) of FIG. 5 are a graph showing relations between a number of printed sheets and amounts of toner charged in the embodiments 1 and 2, and a graph showing a relation between a number of printing sheet and a primary transfer voltage in the embodiment 1.

FIG. 6 is a chart showing an adjusting control for the primary transfer contrast in the embodiment 1.

FIG. 7 is a graph showing a relation between a number of printing sheet of a main assembly and the primary transfer voltage in the embodiment 1.

FIG. 8 is a cross-sectional schematic view explaining other structure of an image forming apparatus in the embodiments 1 and 2.

FIG. 9, part (a) and (b), is a chart showing an adjusting control for the primary transfer contrast in the embodiment 2.

FIG. 10 is a schematic view showing an electric potential relation in the embodiment 2.

Part (a) and part (b) of FIG. 11 are a graph showing a relation between an amount of exposure and a potential of a photosensitive drum in the embodiment 2, and a graph showing a relation between a number of printing sheet and the primary transfer contrast in the embodiment 1, 2 and an embodiment 3.

FIG. 12 is a chart showing an adjusting control for the primary transfer contrast in the embodiment 2.

FIG. 13 is a cross-sectional schematic view explaining a structure of an image forming apparatus in the embodiments 3

FIG. 14 is a schematic view an electric potential relation in the embodiment 3.

### DESCRIPTION OF THE EMBODIMENTS

A present invention will be exemplary described with referring to the drawings as below. Note that, sizes, materials, shapes and relative positions of component parts described in these embodiments are modifiable corresponding to a structure of an apparatus this invention is applied to or variable conditions, and a scope of this invention is not limited to these disclosed embodiments in the following.

### [1. Image Forming Apparatus]

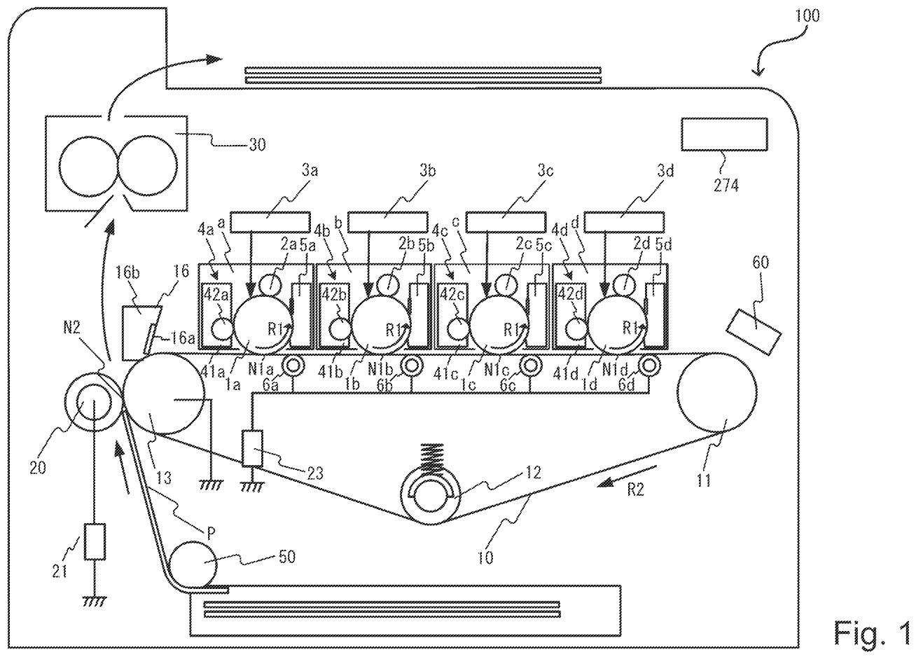

FIG. 1 is a cross-sectional schematic view showing a structure of an image forming apparatus 100 in the embodiment 1. Note that, the image forming apparatus 100 is so-called tandem type of the image forming apparatus which is provided multiple image forming portions (a), (b), (c), and (d). A first image forming portion (a) (hereinafter, simply referred to as an image forming portion (a)) forms an image with a yellow toner (Y) and a second image forming portion (b) (hereinafter, simply referred to as an image forming portion (b) forms an image with a magenta toner (M). A third image forming portion (c) (hereinafter, simply referred to as an image forming portion (c)) forms an image with a cyan toner (C) and a fourth image forming portion (d) (hereinafter, simply referred to as an image forming portion (d) forms an image with a black toner (Bk). These four image forming portions (a), (b), (c), and (d) are arranged in a row with a constant space and their structures are substantially similar except colors of toner accommodated. Therefore, the image forming apparatus 100 in the embodiment 1 will be described with the image forming portion (a) in the following.

The image forming portion (a) includes a photosensitive drum 1a which is a photosensitive member of a drum shape, a charging roller 2a as a charging means, a developing unit 4a as a developing means, and a drum cleaning device 5a. In the embodiment 1 the photosensitive drum 1a, the charging roller 2a, the developing roller 4a, and the drum cleaning device 5a are integrated as a replaceable toner cartridge. Note that, the replaceable toner cartridge may have a structure that includes at least the photosensitive drum 1a and the developing unit 4a or a structure that provides several cartridges for each color.

The photosensitive drum 1a is an image bearing member bearing a toner image and driven to rotate in a direction of an arrow R1 (counterclockwise) in the drawing at a predetermined process speed (for example 200 mm/sec in the embodiment 1). The developing unit 4a includes a developing container 41a as an accommodating portion which accommodates the yellow toner, and a developing roller 42a as a developing member which carries the yellow toner accommodated in the developing container 41a and develops a yellow image on the photosensitive drum 1a. The developing roller 42a rotates with contacting on the photosensitive drum 1a. A toner is a powder of which ground material is thermoplastic resin and includes a pigment to form colors, a parting agent, a charging control agent to control charging amount, and so on. Also, the photosensitive drum 1a is made of a conductive hollow bear pipe such as an SUS (stainless used steel) coated with a photosensitive layer. The drum cleaning device 5a is a means to collect the toner deposited on the photosensitive drum 1a. The drum cleaning device 5a includes a cleaning blade contacting on the photosensitive drum 1a and a waste toner box accommodates the toner and etc. removed from the photosensitive drum 1a by the cleaning blade.

When the image forming operation starts by a control portion 274 such as a DC controller receiving an image signal, the photosensitive drum 1a is driven to rotate. The photosensitive drum 1a is evenly charged at a predetermined potential (a dark portion potential Vd) in a predetermined polarity (negative polarity in the embodiment 1) by the charging roller 2a and receives an exposure by an exposing device 3a of an exposing means corresponding to an image signal as rotating. Thereby, an electrostatic latent image (a light portion potential VL) corresponding to an image of yellow component of an objective multi-colored image is formed. Next, the electrostatic latent image is developed by the developing roller 42a and visualized as a yellow toner image (hereinafter simply referred as a toner image) at a developing position. The developing roller 42a stably develops by rotating in 1.5 times faster speed, for example 300 mm/sec, than the photosensitive drum 1a in a same direction. A voltage is applied to the charging roller 2a as the dark portion potential Vd to be −600V and an exposure amount of the exposing device 3a is determined as the light portion potential VL to be −150V in the embodiment 1. Also, the developing roller 42a is applied with for example −350V as a developing voltage Vdc. An absolute value of a difference between the light portion potential VL and the developing voltage Vdc is called a developing contrast. Note that, an emission strength of a laser light quantity emitted from the exposing device 3a on to the photosensitive drum 1a is for example 0.5 (μJ/cm²) maximum in the embodiment 1.

Here, a normal charging polarity of the toner deposited on the surface developing roller 42a is negative polarity. The toner is supplied on the surface of the developing roller 42a from a toner supplying roller (not showing in the figures) rotating as being contact on the developing roller 42a and the supplied toner is deposited on the surface of the developing roller 42a. By going through a regulating blade (not showing in the figures) contacting on the surface of the developing roller 42a the toner deposited on the surface of the developing roller 42a is levelled at a predetermined thickness and is charged with negative polarity by friction in between the regulating blade.

Though the electrostatic latent image is reversal-developed by the toner charged with the same polarity as a polarity of the photosensitive drum 1a is charged by the charging roller 2a in the embodiment 1, it is not limited to this. For example, it is applied to an image forming apparatus that an electrostatic latent image is developed by a toner charged with an opposite polarity as a polarity of the photosensitive drum 1a charged. In the embodiment 1 more than 150V voltage is needed as a developing contrast in order for the 100% of toner on the developing roller 42a to be developed onto the photosensitive drum 1a when the surface of photosensitive drum 1a is the light portion potential VL.

An intermediary transfer belt 10 which is an endless and movable intermediary transfer member provided in a position where is contact on each image forming portion a, b, c, and d of each photosensitive drum 1a, 1b, 1c, and 1d as being stretched with three shafts of rollers as stretching members; a driving roller 11, a stretching roller 12, and a secondary transfer resisting roller 13. The intermediary transfer belt 10 is stretched in tension of 60 N for example by the stretching roller 12, and is moved in a direction of an arrow R2 in the drawing (clockwise) by the secondary transfer resisting roller 13 rotating by driving force.

The toner image formed on the photosensitive drum 1a is transferred onto the intermediary transfer belt 10 by a positive polarity voltage being applied to a primary transfer roller 6a from a primary transfer power source 23 in a process it goes through a primary transfer nip portion N1a in which the photosensitive drum 1a is contact on the intermediary transfer belt 10 (primary transfer). The primary transfer power source 23 functionates as a primary applying means applies a primary transfer voltage which is a transfer voltage to a primary transfer roller 6 which is a transfer means. Thereafter, a remained toner that left on the photosensitive frum 1a without primary transferring onto the intermediary transfer belt 10 is removed from the surface of the photosensitive drum 1a by a drum cleaning device 5a collecting. Similarly in the following, a toner image of magenta as a second color, a toner image of cyan as a third color, and a toner image of black as a fourth color are formed and is transferred onto the intermediary transfer belt one after another. Therefore, a toner image with four colors corresponding to an objective multi-colored image is formed on the intermediary transfer belt 10.

The primary transfer roller 6 contacting on the intermediary transfer belt 10 is applied voltage at the primary transfer in the embodiment 1. Therefore, electric current flows on an inner circumferential surface of the intermediary transfer belt 10 and a primary transfer potential is formed by this electric current at the primary transfer nip portions N1a, N1b, N1c, and N1d in each image forming portions a, b, c, and d. Thus, there is a feature that the primary transfer rollers 6a, 6b, 6c, and 6d are all applied same primary transfer voltage. After the primary transfer, the toner image with four colors carried by the intermediary transfer belt 10 goes through a secondary transfer nip portion N2 formed between a secondary transfer roller 20 and the intermediary transfer belt 10 by their contacting. In this process the toner image with four colors is transferred all together on a surface of a transfer material (recording material) P such as a printing sheet or an OHP sheet fed from a sheet feeding roller 50 (secondary transfer).

A secondary transfer roller 20 is made of for example an 8 mm outer diameter nickel plated steel rod covered with a foamed sponge body up to 18 mm outer diameter. Here, the foamed sponge body is made of NBR (nitril-butadiene rubber) adjusted to be 10⁸ Ω·cm volume resistivity/5 mm thick and epichlorohydrin rubber. Note that, rubber hardness of the foamed sponge body is 30° hardness rate as weighted 500 g load when it is measured with Asker hardness measure type C. The secondary transfer roller 20 is contact on the outer circumferential surface of the intermediary transfer belt 10, is pressed onto the secondary transfer resisting roller 13 located in a position facing to the secondary transfer resisting roller 20 with 50 N pressure power through the intermediary transfer belt 10, and forms the secondary transfer nip portion N2.

The secondary transfer roller 20 is rotated as following the intermediary transfer belt 10 and electric current flows down to the secondary transfer resisting roller 13 from the secondary transfer roller 20 by being applied voltage from a secondary transfer power source 21. Therefore, the toner image carried by the intermediary transfer belt 10 is secondary-transferred onto the transfer material P at the secondary transfer nip portion N2. Note that, the toner image is secondary-transferred onto the transfer material P by the intermediary transfer belt 10 as following. A voltage applied to the secondary transfer roller 20 from the secondary transfer power source 21 is controlled for electric current flows down to the secondary transfer resisting roller 13 from the secondary transfer roller 20 through the intermediary transfer belt 10 to be constant. Further, a magnitude of electric current to execute secondary transfer is determined beforehand depending on an environment where the image forming apparatus is provided or a kind of transfer material P. the secondary transfer power source 21 is connected to the secondary transfer roller 20 and applies the secondary transfer voltage to the secondary transfer roller 20. Also, the secondary transfer power source 21 is able to output between 100V and 4000V.

After the toner image with four colors is transferred on the transfer material P in the secondary transfer, the transfer material P is heated and pressed in a fixing device which is a fixing means and four colors of toner are melted, mixed and then fixed on the transfer material P. On the other hand, the remained toner on the intermediary transfer belt 10 after the secondary transfer is cleaned and removed by a belt cleaning device 16 (collecting means) provided in the downstream from the secondary transfer nip portion N2 with respect to the moving (rotating) direction. The belt cleaning device 16 includes a cleaning blade 16a which is a contact member and a waste toner container 16b. The cleaning blade 16a which is the contact member is contact on an outer circumferential surface of the intermediary transfer belt 10 at the position facing the secondary transfer resisting roller 13. The waste toner container 16b accommodates the toner collected by the cleaning blade 16a. Note that, the cleaning blade 16a is referred as to a blade 16a in the following explanation. An optical sensor 60 which is a detecting means is used when adjusting control is executed to adjust position or density of an image formed in the image forming apparatus 100. With the operations described above, full-colored printing image is formed in the image forming apparatus 100 in the embodiment 1.

### [2. Explanation of the Control Block View]

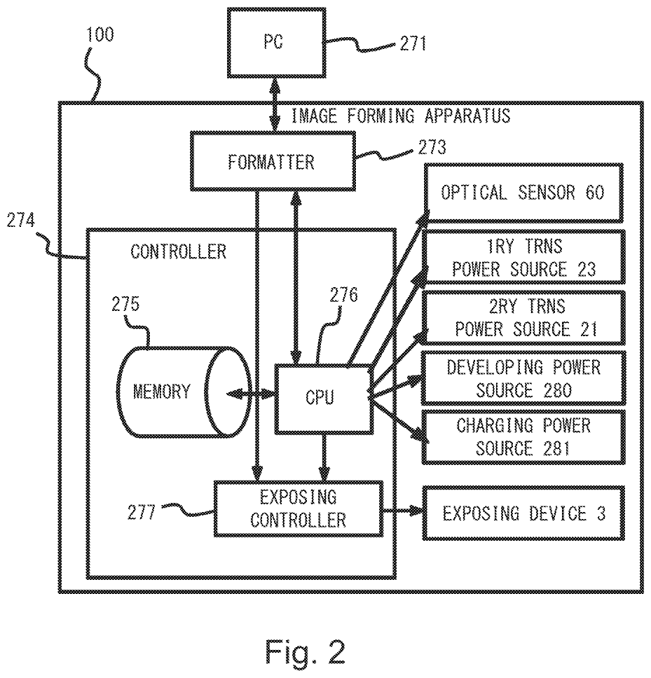

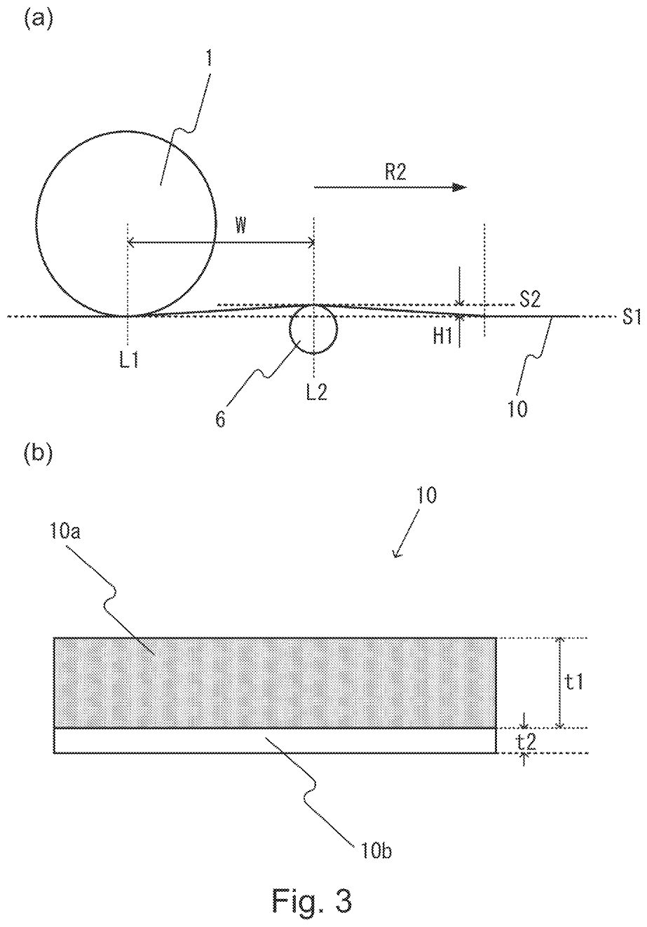

Next, controlling in the embodiment 1 will be described with the control block view. FIG. 2 is the control block view to control operations in the image forming apparatus 100. A PC 271 which is a host computer commands a formatter 273 which is a conversion means to print and sends image data of a printing image to the formatter 273. The formatter 273 receives image data of RGB or CMYK from PC 271 and converts to an exposure data of CMYK following a specified mode. Here, the exposure data converted is for example 600 dpi. The mode specified by PC 271 are modes of kinds, sizes of printing sheet or quality of image.

The formatter 273 forwards the exposure data converted to an exposing control device 277 provided in a control portion 274. The exposing control device 277 controls the exposing device 3 by a command from a CPU 276. In the image forming apparatus 100 in FIG. 2 a half tone control is controlled by adjusting an area by duty of the exposure data. In the embodiment 1 a predetermined half tone control image is formed by adjusting a size of toner dot for example with Dither Matrix method as the half tone control. The CPU 276 starts a sequence of the image forming as receiving a printing command from the formatter 273.

The control portion 274 is equipped with the CPU 276, a memory 275, etc. and programmed to operate beforehand. The CPU 276 executes to form an electrostatic latent image by controlling a charging power source 281, a developing power source 280, the primary power source 23, and the secondary power source 21 and executes image forming by controlling to transfer a developed toner image, etc. Also, the CPU 276 executes process of receiving a signal from the optical sensor 60 when correcting control is executed to correct a position and density of the image formed in the image forming apparatus 100. Note that, the CPU 276 which is a control means controls the primary transfer contrast corresponding to a usage condition of the toner described below. The primary transfer contrast is difference between the potential at the primary transfer nip portion N1 and the potential at the portion where is exposed by the exposing device 3 on the photosensitive drum 1 (on the photosensitive member) when the primary transfer voltage is applied to the transfer roller 6 by the primary transfer power source 23.

### [3. Stretching Structure of the Intermediary Transfer Belt]

The intermediary transfer belt 10, the stretching members of the intermediary transfer belt 10 (the driving roller 11, the stretching roller 12, and the secondary transfer resisting roller 13), and the primary transfer roller 6 will be described in the following. The intermediary transfer belt 10 is provided in a position facing to each image forming portion a, b, c, and d. The intermediary transfer belt 10 is an endless belt added a conductive agent to give conductivity in its resin material and stretched by three shafts of the driving roller 11, the stretching roller 12, and the secondary transfer resisting roller 13, which are the stretching members, in 60 N tension in total pressure by the stretching roller 12.

As shown in FIG. 1, the primary transfer roller 6a, 6b, 6c, and 6d which are contact members contacting on an inner circumferential surface of the intermediary transfer belt 10 is provided downstream of the photosensitive drum 1a, 1b, 1c, and 1d in the rotational direction of the intermediary transfer belt 10. FIG. 3, part (a), is a chart showing relative position between the photosensitive drum 1 and the primary transfer roller 6 and showing an arrow R2 as a rotational direction shown in FIG. 1 as well. Each primary transfer roller 6 is provided downstream in the rotational direction of the photosensitive drum 1 with respect to a perpendicular line L1 to the primary transfer belt 10 from a center of the photosensitive drum 1. Each primary transfer roller 6a, 6b, 6c, and 6d is located as entering a surface of the intermediary belt 10 in order to secure enough amount of the intermediary transfer belt 10 winding around the photosensitive drum 1a, 1b, 1c, and 1d in the corresponding image forming portion a, b, c, and d.

The primary transfer roller 6 which is made from 6 mm outer diameter SUS rod nickel-plated and straight shaped including a metal roller is driven to rotate as following a rotation of the intermediary transfer belt 10. In the embodiment 1 outer diameter of the photosensitive drum 1 is 24 mm, for example. The primary transfer roller 6 is contact on over a predetermined area in its longitudinal side crossing orthogonally a moving direction (the arrow R2) of the intermediary transfer belt 10. Here, a distance between a perpendicular L1 heading to the intermediary transfer belt 10 from the center of the photosensitive drum 1 and a perpendicular L2 heading to the intermediary transfer belt 10 from the center of the primary transfer roller 6 is referred as W. Here, a line connecting a dot where a predetermined photosensitive drum 1 is contact on the intermediary transfer belt 10 and a dot where adjacent photosensitive drum 1 contacting on the intermediary transfer belt 10 is referred as a virtual line S1 in a cross-sectional view of the part (a) of FIG. 3. Further, a parallel line to the virtual line S1 including the dot where the primary transfer roller 6 is contact on the intermediary transfer belt 10 is referred as a virtual line S2. At this point, a distance between the virtual line S1 and the virtual line S2 in the direction of the perpendicular L2 is an amount that the primary transfer roller 6 entering into the area of the intermediary transfer belt 10, or a height (hereinafter, referred as a lifting height) the primary transfer roller 6 lifting the intermediary transfer belt 10 in the other word. The lifting height which the primary transfer roller 6 lift the intermediary transfer belt 10 is defined as HE In the embodiment 1 it is defined that W=10 mm and H1=2 mm. Note that, the primary transfer voltage is applied to the primary transfer roller 6 from the primary transfer power source 23 and the primary transfer current is supplied by going through inside of the inner circumferential layer of the intermediary transfer belt 10.

### [4. Intermediary Transfer Belt]

Next, the intermediary transfer belt 10 will be described. The intermediary transfer belt 10 includes a base layer 10a which is a first layer contacting on the photosensitive drum 1, an inner layer 10b which is a second layer contacting on the primary transfer roller 6 and of which resistance value is lower than the base layer 10a. The part (b) of FIG. 3 is a schematic view showing a cross-sectional view of the intermediary transfer belt 10 used in the embodiment 1. The intermediary transfer belt is 700 mm perimeter, 90 μm thick, and formed with the base layer 10a made of endless polyethylene naphthalate (PEN) mixed with an ionic conductive material as a conductive agent and the inner layer 10b made of an acrylic resin mixed with carbon as a conductive agent. The inner layer 10b is formed inside (stretching shaft side) of the base layer 10a. When a thickness of polyvinylidene fluoride layer of the base layer 10a is referred to t1 and a thickness of the acrylic resin layer of the inner layer 10b is referred to t2, t1=87 μm, and t2=2 μm. Though polyethylene naphthalate (PEN) is used for a material of the base layer 10a of the intermediary transfer belt 10, other materials such as copolymer of polyester, acrylonitrile, butadiene, and styrene (ASB) or mixed resin of these materials may be used. For materials of the inner layer 10b of the intermediary transfer belt 10, other materials than the acrylic resin such as polyester may be used.

In the embodiment 1 volume resistivity measured from a side of the base layer 10a and surface resistivity measured from a side of the inner layer 10b are used as a resistance value of the intermediary transfer belt 10. The volume resistivity is measured by Hiresta-UP (MCT-HT450) of Mitsubishi Chemical Corporation with type UR ring probe (MCP-HTP12 model). A metal surface of UFL registration table is used as an opposite probe electrode. The surface resistivity is measured by the same resistivity meter with type UR 100 ring probe (MCP-HTP16 model). A Teflon (R: registered trademark) surface of UFL registration table is used as an opposite probe electrode.

The volume resistivity is measured from the surface of the intermediary transfer belt 10 by pressing the probe with 1 kg pressure on condition of applying 250V voltage and measuring for 10 seconds. The volume resistivity of the intermediary transfer belt 10 in the embodiment 1 is 3.55×10¹⁰ (Ω·cm). The surface resistivity of the inner layer 10b is measured from the inner surface by pressing the probe with 1 kg pressure on condition of applying 10V and measuring for 10 seconds. The surface resistivity of the inner layer 10b of the intermediary transfer belt 10 in the embodiment 1 is 1.00×10⁶ (Ω·cm). These resistivity values are measured in an environment that a room temperature is 23° C. and a room humidity is 50%.

### [5. Primary Transfer Voltage Control]

Next, the primary transfer voltage control which is a feature of the embodiment 1 will be described. The CPU 276 controls a primary transfer contrast by controlling the primary transfer voltage. A consumption of the toner is shown by a number of printed sheets and the CPU 276 controls the primary transfer voltage to be lower as the number of printed sheets increasing.

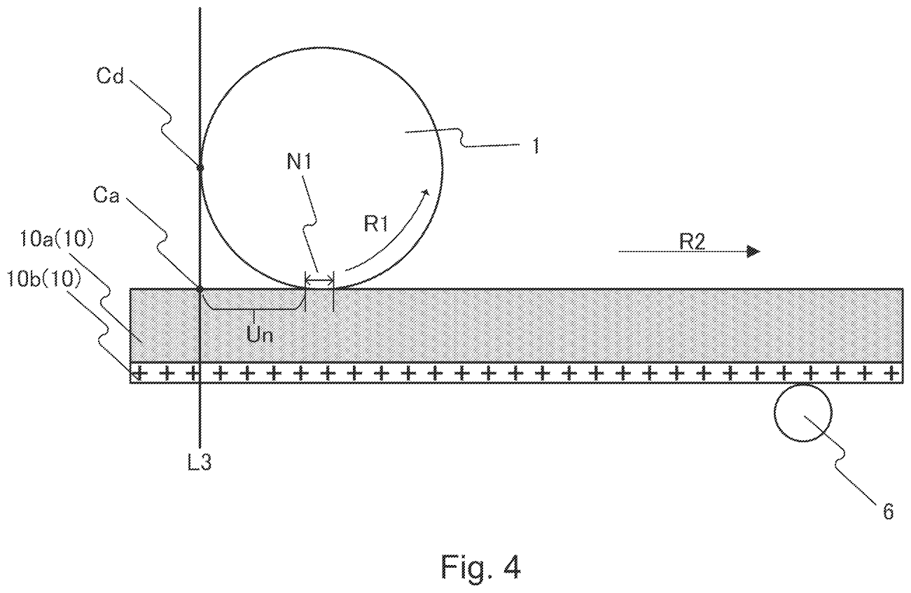

FIG. 4 is a view showing a state of an electric potential formed in the inner surface layer 10b when a positive voltage is applied to the primary transfer roller 6. The surface resistivity of the inner surface layer 10b is low. Thus, a surface potential of the inner surface layer 10b is mostly not decreased and forms almost similar surface potential as a voltage applied to the primary transfer roller 6 (the primary transfer voltage) in a portion from the primary transfer roller 6 to the primary transfer nip portion N1 where is a contact point of the photosensitive drum 1 and the intermediary transfer belt 10. Further, the same potential is formed in an area from the primary transfer nip portion N1 to the inner surface layer 10b upstream in the rotational direction (the arrow R2) of the intermediary transfer belt 10 as the voltage applied to the primary transfer roller 6. In the embodiment 1 a width of the primary transfer nip portion N1 (a length in the moving direction of the intermediary transfer belt 10) is 4 mm.

Hereinafter, in the embodiment 1 each term on a line L3 (or referred as a virtual line L3) which crosses the intermediary transfer belt 10 perpendicularly upstream as described above and is a tangent of the photosensitive drum 1 is defined as follows. A contact point of the virtual line L3 and the photosensitive drum 1 is referred as Cd, a cross point of the virtual line L3 and the surface of the base layer 10a of the intermediary transfer belt 10 is referred as Ca, an area of the surface of the base layer 10a from Ca to the primary transfer nip portion N1 along the intermediary transfer belt is referred as a nip upstream area Un.

When a positive voltage is applied to the primary transfer roller 6, the nip upstream area also has a positive polarity because the potential of the inner surface layer 10b is almost similar with the voltage applying to the primary transfer roller 6. An area where a toner image is formed of the surface of the photosensitive drum 1 (hereinafter, referred as an image forming area) is charged with a light portion potential VI and the toner is charged with negative polarity as well. Therefore, a potential difference occurs between the base layer 10a and the surface of the photosensitive drum 1 in the nip upstream area Un. Further, as a distance between the surface of the photosensitive drum 1 and the base layer 10a becomes narrow from the contact point Cd to the primary transfer nip portion N1 in FIG. 4, a positive discharge current flows out to the photosensitive drum 1 from the base layer 10a in an area exceeds a threshold value of discharge by following Paschen's law. When the positive discharge current flows out, a case which a toner on the photosensitive drum 1 is transferred onto the intermediary transfer belt 10 with the discharge current. Hereinafter, this case is referred as a pre-transfer.

### (Evaluation of Primary Transfer Malfunction and Pre-Transfer)

A table 1 shows a result of malfunction of the primary transfer and evaluation of the pre-transfer image when the primary transfer voltage is changed in a yellow image forming portion a according to a rank and by a number of printed sheets. The result is similar with magenta, cyan, and black.

TABLE 1

| First | | First | Number of Printed sheets | | | | | | | | | | | |
|---|---|---|---|---|---|---|---|---|---|---|---|---|---|---|
| trans | | trans | 0 | | 1000 | | 2000 | | 3000 | | 4000 | | 5000 | |
| voltg | VL | cntrst | Trans | Pre- | Trans | Pre- | Trans | Pre- | Trans | Pre- | Trans | Pre- | Trans | Pre- |
| (V) | (−V) | (V) | malfnct | trans | malfnct | trans | malfnct | trans | malfnct | trans | malfnct | trans | malfnct | trans |
| 100 | 150 | 250 | D | A | D | A | D | A | D | A | B | A | B | A |
| 150 | 150 | 300 | D | A | B | A | B | A | B | A | B | A | A | A |
| 200 | 150 | 350 | D | A | B | A | B | A | A | A | A | A | A | B |
| 250 | 150 | 400 | D | A | B | A | A | A | A | B | A | B | A | B |
| 300 | 150 | 450 | B | A | A | A | A | B | A | B | A | B | A | B |
| 350 | 150 | 500 | A | A | A | B | A | C | A | C | A | C | A | C |
| 400 | 150 | 550 | A | B | A | C | A | C | A | C | A | C | A | C |
| 450 | 150 | 600 | A | C | A | C | A | C | A | C | A | D | A | D |
| 500 | 150 | 650 | A | C | A | D | A | D | A | D | A | D | A | D |

The table 1 shows the primary transfer voltage (V) in a first column, the light portion potential VL (−V) in a second column, and the primary transfer contrast (V) in a third column A fourth column in the table 1 shows the number of printed sheets (printing number) and transfer malfunction and the rank (A, B, C, and D) of pre-transfer as printing 0 sheet, 1000 sheets, 2000 sheets, 3000 sheets, 4000 sheets, and 5000 sheets. In the embodiment 1 usage condition of the toner is told by the number of printed sheets.

First, a definition of a rank transfer malfunction will be described. A rank A is a state that primary transfer malfunction can be slightly recognized even on the photosensitive drum 1. A rank B is a state that the toner which could not be primary-transferred remains on the photosensitive drum 1 after going through the primary transfer nip portion N1. A rank C is a state a deficit on the image by primary transfer malfunction can be slightly recognized. A rank D is a state that a deficit on the image by primary transfer malfunction can be obviously recognized.

Next, a definition of pre-transfer will be described. A rank A is a state that pre-transfer does mostly not occur. A rank B is a state that toner scattering can be spotted as the toner printed on a sheet is observed with a microscope. A rank C is a state that a slight difference of density can be recognized on the image. A rank D is a state that a difference of density can be obviously recognized on the image.

### (Evaluation Result of Primary Transfer Malfunction)

Next, an evaluation result of primary transfer malfunction will be described with the Table 1. Primary transfer malfunction is a defective image that occurs as the toner is not transferred onto the intermediary transfer belt from the photosensitive drum 1 and has characteristic that looks like toner missing in various spots on the image. Also, primary transfer malfunction has characteristic that the defective image suddenly stands out when the voltage becomes less than a predetermined threshold value. A solid image is formed as an image to be evaluated.

### (Check Result of Primary Transfer Malfunction in 0 Printed Sheets)

In the table 1, in the case of printing in the state that the number of printed sheets is almost 0, the result is rank A in printing with 350V or larger primary transfer voltage. The result is rank B in printing with 300V primary transfer voltage. The result is rank D in printing with 250V or less primary transfer voltage.

### (Check Result of Primary Transfer Malfunction in 1000 Printed Sheets)

In the case of printing in the state that the number of printed sheets is almost 1000, the result is rank A in printing with 300V or larger primary transfer voltage. The result is rank B in printing with 150V, 200V, and 250V primary transfer voltage. The result is rank D in printing with 100V or less primary transfer voltage.

### (Check Result of Primary Transfer Malfunction in 2000 Printed Sheets)

In the case of printing in the state that the number of printed sheets is almost 2000, the result is rank A in printing with 250V or larger primary transfer voltage. The result is rank B in printing with 150V and 200V primary transfer voltage. The result is rank D in printing with 100V or less primary transfer voltage.

### (Check Result of Primary Transfer Malfunction in 3000 Printed Sheets)

In the case of printing in the state that the number of printed sheets is almost 3000, the result is rank A in printing with 200V or larger primary transfer voltage. The result is rank B in printing with 150V primary transfer voltage. The result is rank D in printing with 100V or less primary transfer voltage.

### (Check Result of Primary Transfer Malfunction in 4000 Printed Sheets)

In the case of printing in the state that the number of printing sheet is almost 4000, the result is rank A in printing with 200V or larger primary transfer voltage. The result is rank B in printing with 100V and 150V primary transfer voltage.

### (Check Result of Primary Transfer Malfunction in 5000 Printed Sheets)

In the case of printing in the state that the number of printing sheet is almost 5000, the result is rank A in printing with 150V or larger primary transfer voltage. The result is rank B in printing with 100V or less primary transfer voltage.

The results in the table 1 show that the primary transfer voltage with which the primary transfer malfunction occurs tends to be lower as the number of printed sheets increasing. In the case of printing in the state that the number of printing sheet is almost 5000, the primary transfer malfunction is not spotted on the image even with 100V primary transfer voltage in the results.

### (Evaluation Result of Pre-Transfer)

Next, a tendency of pre-transfer will be described. Pre-transfer is a defective image occurs by transferring the toner on the photosensitive drum 1 to the intermediary transfer belt 10 in the nip upstream area Un and is also a defective image that the difference of density occurs by scattering a dot in places on the image. A 50% half tone image is used as the image to be evaluated.

### (Checked Result of Pre-Transfer in 0 Printed Sheets)

In the table 1, in the case of printing in the state that the number of printed sheets is almost 0, the result is rank A in printing with 350V or less primary transfer voltage. The result is rank B in printing with 400V primary transfer voltage. The result is rank C in printing with 450V or larger primary transfer voltage.

### (Check Result of Primary Transfer Malfunction in 1000 Printed Sheets)

Next, in the case of printing in the state that the number of printed sheets is almost 1000, the result is rank A in printing with 300V or less primary transfer voltage. The result is rank B in printing with 350V primary transfer voltage. The result is rank C in printing with 400V and 450V primary transfer voltage. The result is rank D in printing with 500V or larger primary transfer voltage.

### (Check Result of Primary Transfer Malfunction in 2000 Printed Sheets)

Next, in the case of printing in the state that the number of printed sheets is almost 2000, the result is rank A in printing with 250V or less primary transfer voltage. The result is rank B in printing with 300V primary transfer voltage. The result is rank C in printing with 350V, 400V and 450V primary transfer voltage. The result is rank D in printing with 500V or larger primary transfer voltage.

### (Check Result of Primary Transfer Malfunction in 3000 Printed Sheets)

Next, in the case of printing in the state that the number of printed sheets is almost 3000, the result is rank A in printing with 200V or less primary transfer voltage. The result is rank B in printing with 250V and 300V primary transfer voltage. The result is rank C in printing with 350V, 400V, and 450V primary transfer voltage. The result is rank D in printing with 500V or larger primary transfer voltage.

### (Check Result of Primary Transfer Malfunction in 4000 Printed Sheets)

Next, in the case of printing in the state that the number of printed sheets is almost 4000, the result is rank A in printing with 200V or less primary transfer voltage. The result is rank B in printing with 250V and 300V primary transfer voltage. The result is rank C in printing with 350V and 400V primary transfer voltage. The result is rank D in printing with 450V or larger primary transfer voltage.

### (Check Result of Primary Transfer Malfunction in 5000 Printed Sheets)

Next, in the case of printing in the state that the number of printing sheet is almost 5000, the result is rank A in printing with 150V or less primary transfer voltage. The result is rank B in printing with 200V, 250V, and 300V primary transfer voltage. The result is rank C in printing with 350V and 400V primary transfer voltage. The result is rank D in printing with 450V or larger primary transfer voltage. The results above show that the primary transfer voltage with which the pre-transfer occurs tends to be lower as the number of printed sheets increasing.

### (Relation of the Number of Printed Sheets and the Amount of Toner Charge)

Next, the reason that the primary transfer voltage with which the primary transfer malfunction and the pre-transfer occurs is lower as the number of printed sheets increasing will be described. FIG. 5, part (a), is a graph showing correlation between the number of printed sheets and the toner charge amount with negative polarity. In FIG. 5, part (a), a vertical axis shows the negative charge amount of the toner formed on the photosensitive drum 1 and a horizontal axis shows the number of printed sheets. As FIG. 5, part (a), showing, the charge amount of the toner (hereinafter, referred as the toner charge amount) tends to be lower as the number of the printed sheets increasing. About the toner charge amount a slope showing the toner charge amount decreases tends to be steep while the number of printed sheets is low and to be less steep as the number of printed sheets increasing. As some of the causes of the toner charge amount decreasing in the embodiment 1, the toner being cramped by the developing roller 42a and the supplying roller or an excessive consumption of a voltage control agent controlling the toner charge amount by friction between the toner and a regulating blade while the number of printed sheets is low in the beginning is brought up.

### (Relation Between the Number of Printed Sheets and the Primary Transfer Voltage)

Next, the relation between the number of printed sheets and the primary transfer voltage will be described. As the table 1 showing, the primary transfer malfunction tends to increase while the primary transfer voltage decreases. Because an amount of the toner moving from the photosensitive drum 1 to the intermediary transfer belt 10 in the primary transfer nip portion N1 is decreasing when the primary transfer current is decreasing. In other words, the primary transfer voltage is needed be larger because the more toner charge amount, the more toner moving current amount needed. As described in FIG. 5, part (a), the larger primary transfer voltage is needed, because the toner charge amount with the negative polarity is larger when the number of printed sheets is fewer in the embodiment 1. On the other hand, it is preferable to decrease the primary transfer voltage because the less amount of current is needed when the toner charge amount is decreasing as the number of printed sheets increasing.

Next, a relation between the toner charge amount and the pre-transfer will be described. In the image forming apparatus of the embodiment 1, a discharge current occurs in the nip upstream area Un as well because the base layer 10a of the intermediary transfer belt is charged with positive polarity. The negative polarity of the toner charge amount is decreasing or reversing to the positive polarity by the discharge current going through the toner image on the photosensitive drum 1. Thus, as phenomenon that a portion of the toner image on the photosensitive drum 1 is transferred onto the nip upstream area Un on the intermediary transfer belt 10 is the pre-transfer. As the negative charge amount of the toner image on the photosensitive drum 1 increasing, the negative charge amount is kept at high rate if the discharge current goes through and hardly occurs the pre-transfer. This feature means, when the number of printed sheets is lower and the negative charge amount is larger, the primary transfer voltage that causes the pre-transfer is larger.

As described above, the primary transfer voltage that causes the primary transfer malfunction and the pre-transfer depends on the negative charge amount of the toner. In view of the tendency in the table 1, a controlling method is needed to consider a balance the primary transfer voltage not to make these image malfunction occur. Specifically, the primary transfer voltage is controlled to be lower corresponding to the number of the printed sheets.

### (Controlling the Primary Transfer Voltage)

FIG. 5, part (b), is a graph of the controlling method of the primary transfer voltage discovered by reflecting the results of the table 1 and is showing the number of printed sheets on a horizontal axis and the primary transfer voltage (V) on the vertical axis. 350V primary transfer voltage is selected in a brand-new state which the number of printed sheets is low, 200V primary transfer voltage is selected when the number of printed sheets is 3000. Further, between the brand-new state and 3000 sheets the primary transfer voltage is controlled to decrease corresponding to the number of printed sheets down to be 200V at 3000 sheets in linear function. Furthermore, the primary transfer voltage is 200V as a predetermined value after 3000 sheets. As described above, in the embodiment 1 CPU 276 controls the primary transfer voltage to decrease from an initial value (for example 350V) which is the primary transfer voltage when the number of printed sheets is 0 in linear function corresponding to the number of printed sheets until the number of printed sheets reaches the predetermined number (for example 3000 sheets). After the number of printed sheets reaches the predetermined number (for example 3000 sheets), CPU 276 keeps the primary transfer voltage a predetermined value.

In an example in FIG. 5, part (b), the primary transfer voltage is controlled to decrease corresponding to the number of printed sheets in linear function until printing 3000 sheets and to select a predetermined value after 3000 sheets printing. However, in a case of the image forming apparatus that an amount of changed value of the toner charge amount is different from the embodiment 1, a proper control may be executed corresponding to its tendency. For example, in a case that the toner charge amount decreases in linear function corresponding to the number of printed sheets, the primary transfer voltage may be continuously decreased corresponding to the number of printed sheets in a constant determined slope without providing a changing point (the changing point at 3000 sheets) such as the changing point in FIG. 5, part (b).

Note that, though the primary transfer voltage is selected corresponding to the number of printed sheets in FIG. 5, part (b), the primary transfer voltage may be selected with respect to other parameter corresponding to a change of the toner charge amount. For example, it is possible to select the primary transfer voltage corresponding to an amount of the toner consumed (hereinafter, referred as toner consumption amount) as counting the toner amount consumed by printing. In other words, a usage state of the toner is shown by the consumption of the toner and CPU 276 may control the primary transfer contrast corresponding to the amount of toner consumption. Further, in a case that such as deterioration of the toner (hereinafter, referred as toner deterioration) by sliding on a developing member is dominant as decrease of the toner charge amount, the primary transfer voltage may be selected with a rotational number of the developing member as a parameter. In other words, the toner usage state may be shown by a cumulated rotational number of the developing roller 42 and the CPU 276 may control the primary transfer contrast corresponding to the cumulated rotational number.

Furthermore, a value that is multiplied the rotational number of the developing member and the toner consumption amount is defined as a toner deteriorating index number and the primary transfer voltage corresponding to the toner deteriorating index number may be selected. Also, when an outer diameter of the photosensitive drum 1 is changed, a distance between the surface of the photosensitive drum 1 in the nip upstream area Un and the surface of the base layer 10a of the intermediary transfer belt 10. Therefore, a proper value of the primary transfer voltage is changed corresponding to a property of the image forming apparatus because a threshold value that the discharge current occurs is changed and the primary transfer voltage that the difference of the density occurs by the pre-transfer is changed as well.

Next, a way how the excellent primary transfer voltage to be selected as including all image forming portion a, b, c, and d will be described. In the embodiment 1 a same primary transfer voltage is applied to all the primary transfer roller 6a, 6b, 6c, and 6d, therefore, the primary transfer voltage is cannot be selected for each image forming portion a, b, c, and d. Therefore, as considered the primary transfer voltage the primary transfer malfunction and the pre-transfer those which are expected by the number of printed sheets of each image forming portion a, b, c, and d occurs, the primary transfer voltage needs to be selected based on a balance of these.

As described above, the image malfunction tends to stand out when the primary transfer voltage is less than a threshold value about the primary transfer malfunction. Therefore, in the embodiment 1 the primary transfer control is executed to the image forming portion with the least number of printed sheets not to occur the primary transfer malfunction. In order to execute this control, the primary transfer voltage control is executed corresponding to the number of printed sheets based on FIG. 5, part (b) as a starting point when any color of toner cartridge is replaced.

### (Process Determination of the Primary Transfer Voltage)

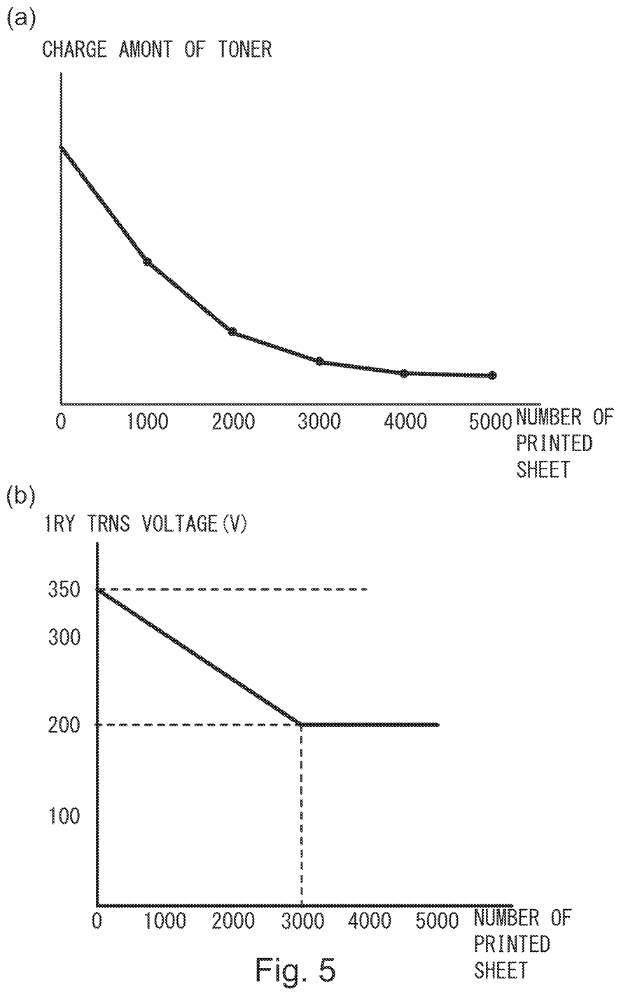

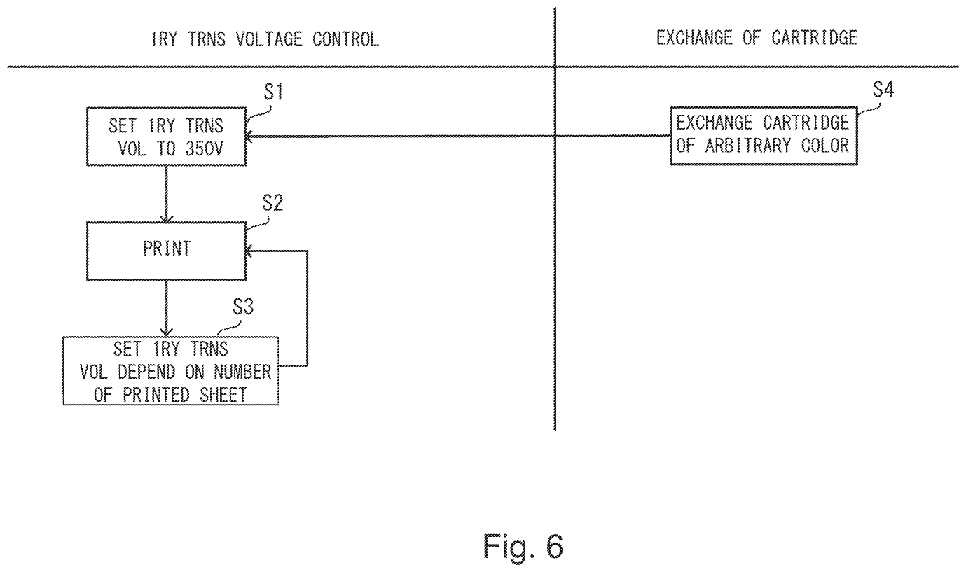

FIG. 6 is a view showing a process determination of the primary transfer voltage like a flowchart. The primary transfer voltage controls the CPU 276 executing in a left side of FIG. 6 and a replacing operation of the cartridge in a right side separately. As described in part (b) of FIG. 5, in a step (hereinafter, referred as S) 1 the CPU 276 sets the primary transfer voltage to be 350V which is an initial value. In S2 the CPU 276 executes the printing operation. Note that, the CPU 276 is regarded as including a counter (not shown in the drawing) counting the number of printed sheets and counts all number of printed sheets since the primary transfer voltage is set to 350V in S1.

In S3 the primary transfer voltage corresponding to the number of printed sheets is set. The primary transfer voltage is set to a targeted voltage for each determined number of printed sheets and a relation between the number of printed sheets and the primary transfer voltage to be in linear function by when the number reaches the predetermined number of printed sheets. In FIG. 5, part (b), the targeted voltage is 350V at 0 sheets and 200V after 3000 sheets. While the number of printed sheets is between 0 and 3000 in S3, the primary transfer voltage is set with a linear interpolation between 0 sheets and 3000 sheets, 350V and 200V.

Also, in spite of a state of an operation of the primary transfer voltage control in the left side of FIG. 6, a cartridge of any color is replaced in any timing shown in S4. As executing S4, the CPU 276 executes a process of S1 in the processing in the left side of FIG. 6 and sets the primary transfer voltage to be 350V. As described above, the primary transfer voltage is back to 350V of initial value and the counter counting the number of printed sheets is initialized to be 0 corresponding to the replacing the new cartridge.

### Transition of the Primary Transfer Voltage in the Embodiment 1

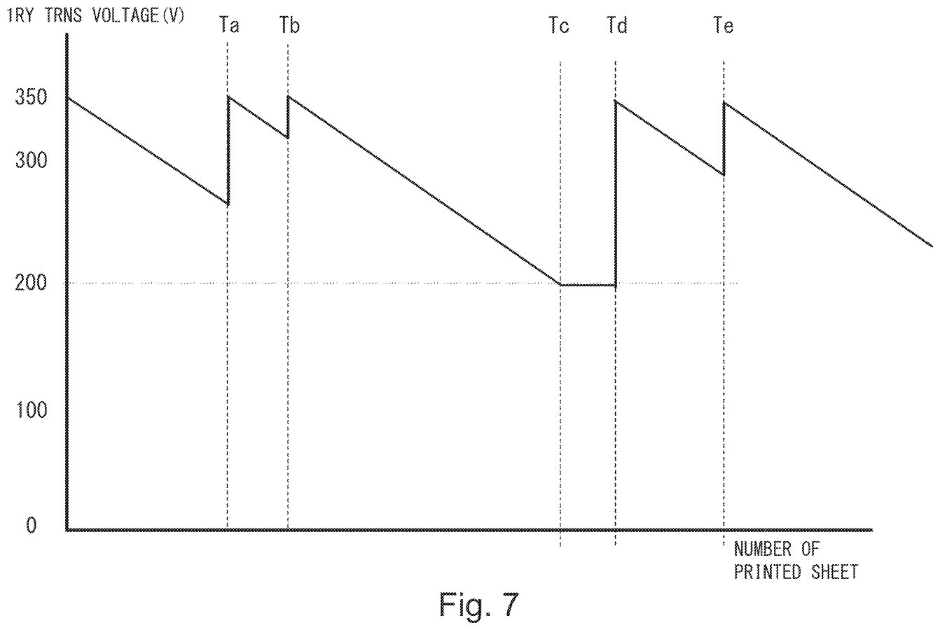

FIG. 7 is an example of the primary transfer voltage control operated based on the flowchart in FIG. 6 and showing a control method of the primary transfer voltage control with respect to the number of printed sheets in a main assembly of the image forming apparatus 100. In FIG. 6, a horizontal axis shows the number of printed sheets of the main assembly of the image forming apparatus 100 (main assembly printing sheet number) and a vertical axis shows the primary transfer voltage (V) determined by the primary transfer voltage control in FIG. 6. A point Ta, a point Tb, a point Tc, and a point Td in FIG. 7 are timings of replacing a toner cartridge. A cyan cartridge (the third image forming portion c) is replaced in the point Ta, a black cartridge (the fourth image forming portion d) is replaced in the point Tb, a yellow cartridge (the first image forming portion a) is replaced in the point Td, and a magenta cartridge (the fourth image forming portion e)

When the main assembly printing sheet number is 0, the cartridges of all colors are new and the toner charge amount of all colors is the highest. Therefore, 350V primary transfer voltage is selected as the initial value. This corresponds to an operation in S1 in FIG. 6. As the main assembly printing sheet number increasing, the primary transfer voltage applied decreases corresponding to the toner charge amount decreasing. This corresponds to an operation in S2, S3, and S4 in FIG. 6. In the point Ta, as the cyan cartridge is replaced, the cyan toner charge amount goes high. There is a risk that the primary transfer malfunction of cyan occurs if the same primary transfer voltage is selected as before the cyan cartridge is replaced in this state. Thus, 350V primary transfer voltage is selected (back to the initial value) to prevent from occurring the primary transfer malfunction in the embodiment 1. This corresponds to an operation in S4 to S1 in FIG. 6.

Then, the lower primary transfer voltage is selected to apply corresponding to the main assembly printing sheet number in the point Ta as a starting point, 350V primary transfer voltage is selected again in the point Tb when the timing the black cartridge is replaced to prevent from occurring the primary transfer malfunction. Further, the lower primary transfer voltage is selected to apply corresponding to the main assembly printing sheet number in the point Tb as a starting point, the primary transfer voltage in the point Tc is 200V. Since the minimum primary transfer voltage selected is 200V in part (b) of FIG. 5, the primary transfer voltage selected from the point Tc to Td is 200V fixed. The point Td is a timing when a yellow cartridge is replaced and then the primary transfer voltage is 350V again. Then, until the point Te the timing when a magenta cartridge is replaced, the selected primary transfer voltage is decreasing corresponding to the main assembly printing sheet number.

Hereinafter, the CPU 276 selects 350V for the primary transfer voltage in the timing when the cartridge of any color is replaced in any timing and selects the lower primary transfer voltage corresponding to the main assembly printing sheet number from the timing when the cartridge is replaced. By executing these controls, it is possible to select the primary transfer voltage that suppresses the primary transfer malfunction and the pre-transfer despite each color or each number of printed sheets. As described above, the CPU 276 restores the primary transfer voltage to the initial value in spite of the printing number as the cartridge is replaced and controls the primary transfer voltage corresponding to the number of printed sheets that printed after restoring the initial value.

In an example in FIG. 7, though 350V primary transfer voltage is selected in the timings when any of the toner cartridges out of yellow, magenta, cyan, and black is replaced, it is also possible to select the color that switches the primary transfer voltage as considering an effect to an image quality. For example, an image of yellow has characteristic that it is harder to see the image malfunction than the other colors even if the primary transfer malfunction or the pre-transfer is as same degree as the other colors. Therefore, it is possible to execute the primary transfer voltage control as FIG. 7 for the timing to replace the toner cartridge of any color of magenta, cyan, and black except yellow.

In the embodiment 1, in the image forming apparatus using the intermediary transfer belt including the inner surface conductive layer, the method to suppress that the primary transfer malfunction and the pre-transfer caused by the discharge current in the nip upstream area occur has been described above. In order to supply the excellent primary transferred image the controlling method which the lower primary transfer voltage is applied as the toner charge amount is less is described in the embodiment 1. Further, the control method that the primary transfer is selected corresponding to the replaced toner cartridge in the timing when the toner cartridge is replaced as considering the characteristic that all image forming portions have the same primary transfer voltage was described above.

### [Other Structure of the Image Forming Apparatus]

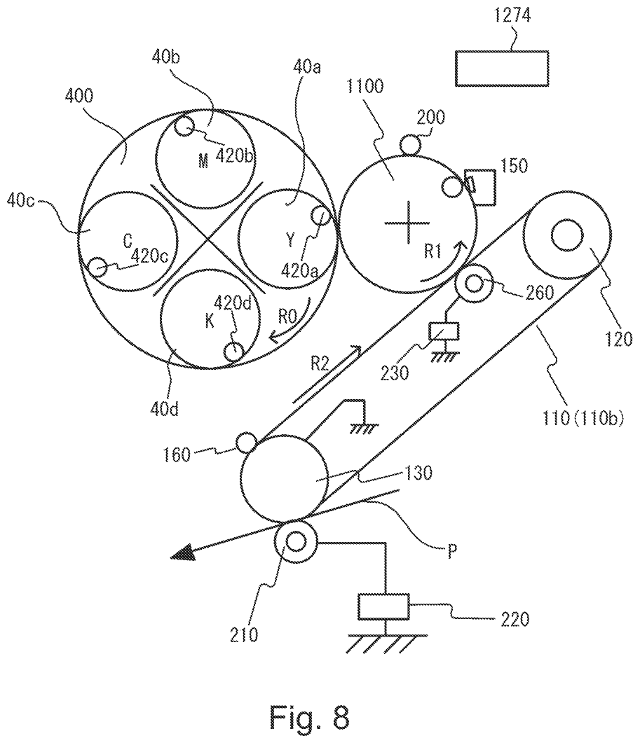

As FIG. 1 showing, though the image forming apparatus was described in the embodiment 1 with the image forming apparatus 100 including multiple photosensitive drums 1 in a tandem system, the control method in the embodiment is effective with the image forming apparatus with not only the tandem system but a rotary system shown in FIG. 8. In FIG. 8, a control portion 1274 controls the primary transfer contrast corresponding to the usage state of the toner.

The image forming apparatus in FIG. 8 includes a single photosensitive drum 1100 that is rotatable in a direction R1. A rotary 400 can switch a developing member 420 contacting on the photosensitive drum 1100 by rotating. By the rotary 400 rotating in a direction R0 one of the developing members 420a, 420b, 420c, and 420d comprising of a Yellow (a), Magenta (b), Cyan (c), and Black (d) contacts on the photosensitive drum 1100. Each developing member 420a, 420b, 420c, or 420d rotates by contacting on the photosensitive drum 1100. Hereinafter, following reference letters indicating colors are sometimes omitted except explaining the specific color. The image of each color is transferred onto an intermediary transfer belt 110 by that the toner image is formed on the photosensitive drum 1100. In the image forming apparatus in FIG. 8 the characteristics of the members for the image forming apparatus is the same except for the size with FIG. 1 and an intermediary transfer belt 110 that moves in a direction R2 includes an inner surface layer 110b which is a conductive layer.

A toner image formed on the photosensitive drum 1100 to which a primary transfer roller 260 applies a positive voltage in a primary transfer nip portion is transferred onto the intermediary transfer belt 110. The toner image is conveyed on the intermediary transfer belt 110 and reaches the primary transfer nip portion again in order to form a multi-colored image in the image forming apparatus in FIG. 8. In the timing when the image that was executed the primary transfer earlier, the rotary 400 rotates about 90° in the direction R0 and a next color is developed to execute the primary transfer as overlapping on the intermediary transfer belt 110. Note that, during executing the primary transfer repeatedly a secondary transfer roller 210 and a toner charging roller 160 are separated from the intermediary transfer belt 110. As the toner image with four colors is formed on the intermediary transfer belt 110, the secondary transfer roller 210 is contact on the intermediary transfer belt 110, a predetermined voltage is applied, and the multi-colored toner image is secondary-transferred on a recording material P.

Since the discharge current occurs in the nip upstream area and the pre-transfer occurs in the image forming apparatus in FIG. 8 as well, it is necessary to select the primary transfer voltage to obtain an excellent primary-transferred image balanced with the primary transfer malfunction. Also, since the toner charge amount is decreasing as the number of printed sheets increasing, the proper primary transfer voltage to obtain an excellent primary-transferred image is changing. In the image forming apparatus with the rotary system, it is possible to select the proper primary transfer voltage corresponding to the timing when the next color is developed as the rotary 400 is rotated.

Note that, the image forming apparatus with the rotary system is provided a developing unit of each color 40a, 40b, 40c, and 40d, a charging roller 200, a drum cleaning device 150, a driving roller 120, a pair of secondary transfer rollers 130, a primary transfer power source 230, and a secondary transfer power source 220. The rotary 400 includes the multiple developing units including the developing member 420 and an accommodating portion accommodates toner and in the image forming apparatus in FIG. 8 each controlling is executed by a control portion 1274. Further, the each developing unit 40a, 40b, 40c, and 40d is detachable and replaceable from the main assembly of the image forming apparatus. Hereinafter, the developing unit 40a, 40b, 40c, and 40d is sometimes referred to as a cartridge.

### (The Determination Process of the Primary Transfer Voltage)

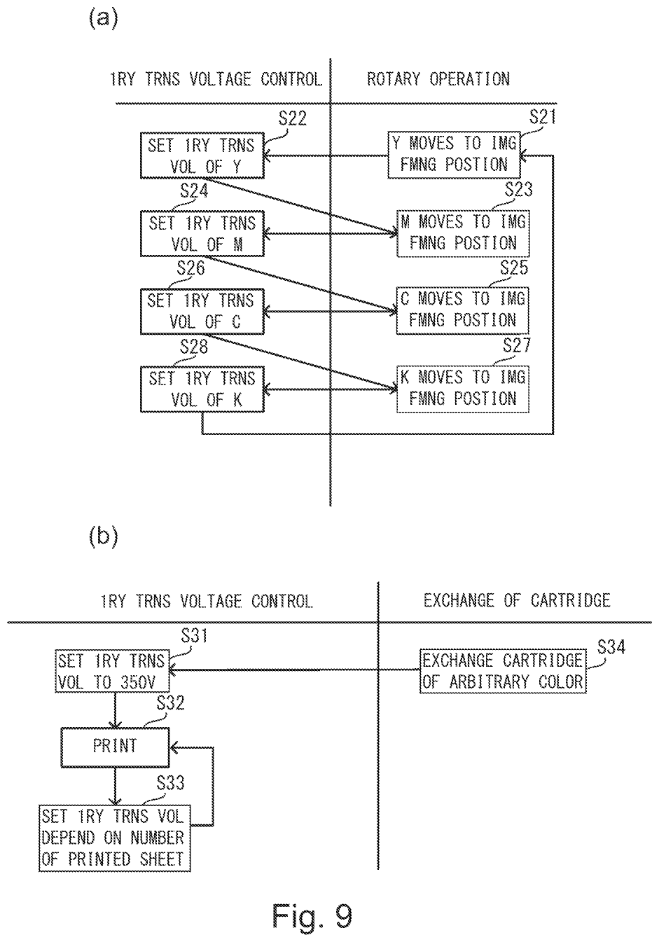

FIG. 9, part (a), is a chart like a flowchart showing a process to determine the primary transfer voltage for each developing color when the image forming apparatus in FIG. 8 forms the multi-colored image in order of Y, M, C, and K. The control portion 1274 can control the primary transfer contrast by controlling the primary transfer voltage in the image forming apparatus with the rotary system as well. The toner usage state is shown by the number of printed sheets and the control portion 1274 controls the primary transfer voltage to decrease as the number of printed sheets increasing. For example, as showing in FIG. 5, the control portion 1274 may control the primary transfer voltage to decrease in linear function to the number of printed sheets from the threshold value which is the primary transfer voltage when the number of printed sheets is 0 until the number of printed sheets reaches the predetermined number of printed sheets. The control portion 1274 may keep the primary transfer voltage being the predetermined value after the number of printed sheets reaches the predetermined number of printed sheets. Note that, the control portion 1274 controls the primary transfer voltage each time when the developing unit 40 switches.

In FIG. 9, part (a), the primary transfer voltage control is shown in the left side and the operation of the rotary 400 is shown in the right side. In S21, the control portion 1274 controls the Y developing unit 40a to move to an image forming position by rotating the rotary 400. Here, the image forming position is the position where the Y developing unit 40 is contact on the photosensitive drum 1100. In S22, the control portion 1274 sets the primary transfer voltage for Y. Next, in S23, the control portion 1274 controls the M developing unit 40b to move to the image forming position by rotating the rotary 400 when forming image Y ends. In S24, the control portion 1274 sets the primary transfer voltage for M.

Next, in S25, the control portion 1274 controls the C developing unit 40c to move to the image forming position by rotating the rotary 400 when forming image M ends. In S26, the control portion 1274 sets the primary transfer voltage for C. Next, in S27, the control portion 1274 controls the K developing unit 40d to move to the image forming position by rotating the rotary 400 when forming image of C ends. In S28, the control portion 1274 sets the primary transfer voltage for K. When forming image of K ends, as going back to the process in S21, the control portion 1274 controls the Y developing unit 40a again to move to the image forming position by rotating the rotary 400 in order to form a next image.

FIG. 9, part (b), is a flowchart explaining a method of the primary transfer voltage control for each color. That is, FIG. 9, part (b), indicates the processes of S22, S24, S26, or S28 in FIG. 9, part (a). Note that, in FIG. 9, part (b), though a process of Y that is S22 is explained as an example, the same control is executed in a process M that is S24, a process C that is S26, or a process K that is S28. Also, in FIG. 9, part (b), the primary transfer voltage control is shown in the left side, an operation to replace a cartridge is shown in the right side. In the image forming apparatus with the rotary system, the CPU 276 controls the primary transfer voltage to be an initial value in spite of the number of printed sheets when the developing unit 40 (or the cartridge) is replaced and controls corresponding to the number of printed sheets after the primary transfer voltage being back to the initial value.

Note that, processes in S31, S32, S33, and S34 in FIG. 9, part (b) are the same as processes in S1, S2, S3, and S4. In other words, when the Y developing unit 40a is new, the control portion 1274 sets the primary transfer voltage to be 350V which is the initial value in S31. As shown in S32 and S33, the control portion 1274 sets the primary transfer voltage to decrease as the number of printed sheets increases. In an example in FIG. 9, part (b), after the primary transfer voltage becomes 200V, the primary transfer voltage not decreased but kept 200V even printing goes on. When the Y cartridge, for example, is replaced in S34, the control portion 1274 sets the primary transfer voltage to be 350V (the initial value) back into S31 and then S32, S33, and S34 are repeated. As described above, in the image forming apparatus with the rotary system, the proper primary transfer voltage can be selected corresponding to the deteriorated degree of toner of each color in the timing when the color in which the image formed is changed by rotating of the rotary 400.

Further, in the image forming apparatus in FIG. 8, in a case the voltage cannot be switched before the image forming timing when the primary transfer voltage takes for a long time to start up or the process speed is too fast, the primary transfer voltage may be controlled as below. In other words, even the image forming apparatus with the rotary system may be controlled as shown in FIG. 6. For more details, in the timing when the cartridge of any color is replaced, the primary transfer voltage may be set corresponding to this cartridge and set to decrease as the number of printed sheets decreases.

As described above, according to the embodiment 1, an excellent primary transfer performance can be obtained even in the image forming apparatus with the intermediary transfer belt including the inner low resistance layer.

The primary transfer contrast which is a difference between the primary transfer voltage and the potential of the surface of the photosensitive drum 1 (hereinafter, referred as a surface potential) contributes to the primary transfer performance. In the embodiment 1 the method which the excellent primary transfer performance is obtained by controlling the primary transfer voltage was described. In an embodiment 2, about the primary transfer contrast, a method that adjusts the surface potential of a photosensitive drum 1 adding to a primary transfer voltage as a method that forms a proper primary transfer contrast considering a balance between a primary transfer malfunction and a pre-transfer will be described. An image forming apparatus in the embodiment 2 is the same as the image forming apparatus in FIG. 1. Only a primary transfer voltage control method and a method that an exposure control method to form the surface potential of the photosensitive drum 1 by an exposing device 3 are different from the embodiment 1. A CPU 276 in the embodiment 2 controls the primary transfer contrast by controlling the primary transfer voltage and the surface potential of the photosensitive drum 1.

### [The Primary Transfer Contrast]

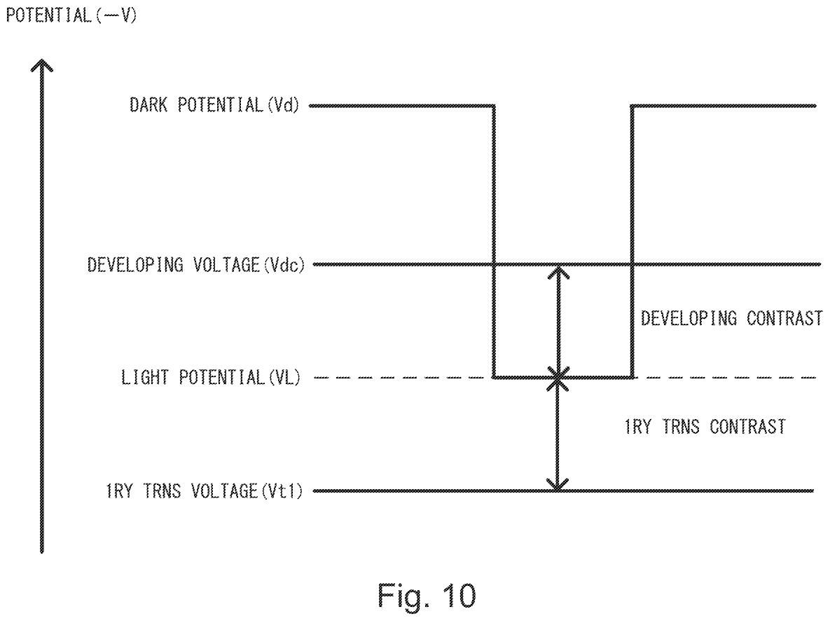

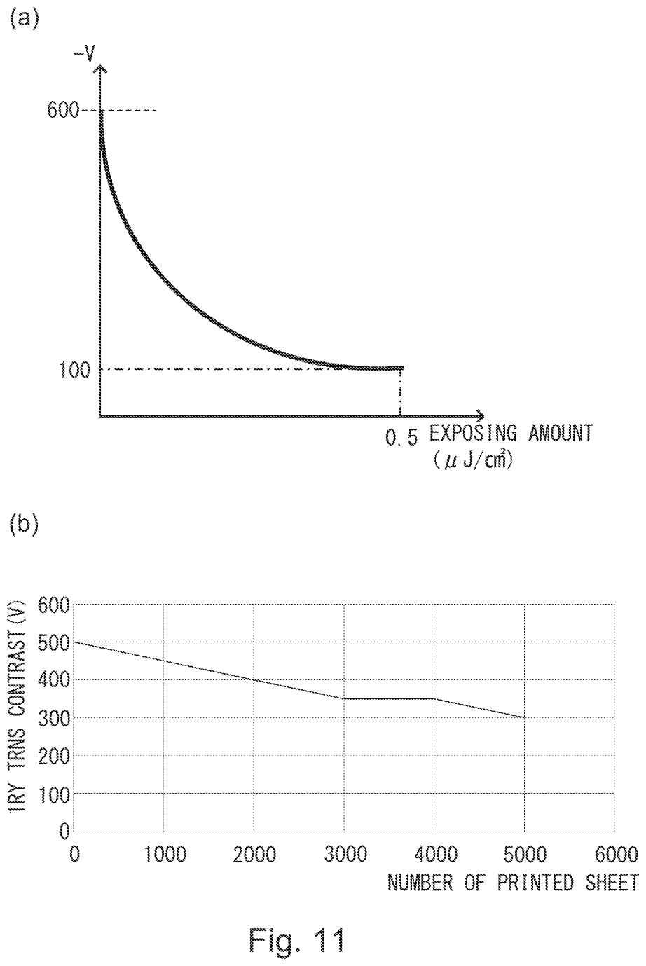

First, the primary transfer contrast will be described with an image forming portion a as an example. FIG. 10 is a schematic view to explain a relation between the primary transfer voltage and the surface of the photosensitive drum 1a and shows a potential (−V) in a vertical axis. A dark portion potential (Vd) in FIG. 10 is the surface potential of the photosensitive drum 1 after charging by a charging roller 2a. The surface potential of the photosensitive drum 1a is evenly charged to be Vd right after the photosensitive drum 1a passes through the charging roller 2a applied a voltage. And then, the photosensitive drum 1a receives an exposure corresponding to an image signal by an exposing device 3a at an exposing position. Therefore, a light portion potential VL corresponding to a yellow color component image in an objective multi-colored image is formed. Also, a developing voltage (Vdc) is applied to a developing roller 42a and toner on the developing roller 42a is developed on the surface of the photosensitive drum 1a by a potential difference between the developing voltage Vdc and the light portion potential VL. Thus, a toner image is formed on the light portion potential VL in the surface of the photosensitive drum 1a. The potential difference between the developing voltage Vdc and the light portion potential VL is a developing contrast.

In the nip upstream area Un described in the embodiment 1, the discharge current occurs by the difference between the light portion potential VL and the potential of the intermediary transfer belt 10. The potential of the intermediary transfer belt 10 is almost similar by the inner surface layer 10b upstream and downstream of the primary transfer nip portion N1 with respect to the rotational direction of the intermediary transfer belt 10. In the embodiment 2, an absolute value |VL-Vt1| of the difference between the light portion potential VL and a primary transfer voltage (Vt1) is defined as a primary transfer contrast. As the primary transfer contrast is larger, the discharge current occurs more often in the nip upstream area Un. The embodiment 2 is characterized that the primary transfer contrast is adjusted by adjusting the light portion potential VL with the exposing device 3a as adding to the primary transfer voltage.

FIG. 11, part (a), is a graph showing a relation between an exposure amount of a laser emitted by the exposing device 3a and the surface potential of the photosensitive drum 1a. A horizontal axis in FIG. 11, part (a), shows the exposure amount (μJ/cm²) and a vertical axis shows the surface potential (negative potential) of the photosensitive drum 1a (−V). As FIG. 11, part (a), shown, as the exposure amount is larger, the absolute value of the surface potential of the photosensitive drum 1a is less. However, as the exposure amount is larger, an amount of change of the surface potential of the photosensitive drum 1a is less with respect to the exposure amount and tends to saturate about 0.5 (μJ/cm²) with 100V. Further, in a case that the primary transfer contrast is adjusted by the surface potential of the photosensitive drum 1a, it is necessary to be adjusted in a range satisfied with the developing contrast. Therefore, as compared with in the case the primary transfer voltage is adjusted, an adjusting range is smaller.

On the other hand, in the image forming apparatus in FIG. 1, it is possible to set the exposure amount for each image forming portion a, b, c, and d. Then, in the embodiment 2 is characterized that each image forming portion adjusts the exposing amount and a proper primary transfer contrast is set for each image forming portion to obtain an excellent primary transfer voltage after the primary transfer contrast that is a base by adjusting the primary transfer voltage. As an example, a method to set the primary transfer contrast when numbers of printed sheets of Y, M, and C are 0, and a number of printed sheets of K is 5000 will be described below. The method of controlling the primary transfer voltage is the same as the embodiment 1, and the occurrence rank of the primary transfer malfunction and the pre-transfer for the primary transfer voltage by each number of printed sheets is the same for each color in the table 1.

### (Evaluation of the Primary Transfer Malfunction and the Pre-Transfer)

Since the number of printed sheets of Y, M, and C are 0, the primary transfer voltage is set to be 350V of the initial value as following FIG. 6. A table 2 is a table showing the occurrence rank of the primary transfer malfunction or pre-transfer of each color, when the primary transfer voltage is set to be 350V. Since the light portion potential VL is −150V, the primary contrast is 500V (=|−150V−350V|).

TABLE 2

| | First | | First | | | | | | | | |
|---|---|---|---|---|---|---|---|---|---|---|---|
| | transfer | | transfer | Y (0 sheets) | | M (0 sheets) | | C (0 sheets) | | K (5000 sheets) | |
| | voltage | VL | contrast | Transfer | Pre- | Transfer | Pre- | Transfer | Pre- | Transfer | Pre- |
| | (V) | (−V) | (V) | malfunction | transfer | malfunction | transfer | malfunction | transfer | malfunction | transfer |
| a | 350 | 150 | 500 | A | A | A | A | A | A | A | C |
| b | 350 | 100 | 450 | B | A | B | A | B | A | A | B |

The table 2 shows the primary transfer voltage (V) in a first column, the light portion potential (−V) in a second column, and the primary transfer contrast (V) in a third column. In the table 2, the rank (A, B, C, or D) of the primary transfer malfunction or the pre-transfer is shown when the number of printed sheets of Y in a fourth column, M in a fifth column, and C in a sixth column are 0 sheets. In seventh column in the table 2, the rank (A, B, C, or D) of the primary transfer malfunction or the pre-transfer is shown when the number of printed sheets of K is 5000.

In an ‘a’ row in the table 2, evaluation results are shown in a case that the light portion potential VL is set to −150V as same as the embodiment 1. The primary transfer contrast is 500V. The rank of both primary transfer malfunction and pre-transfer of Y, M, and C are the rank A, because the number of printed sheets of Y, M, and C are 0 and the primary transfer voltage is proper setting value for 0 sheets. On the other hand, about K, the pre-transfer is the rank C though the primary transfer malfunction is the rank A. Because, the number of printed sheets of K is 5000 and the toner charge amount decreases by toner deterioration.

In a ‘b’ row in the table, evaluation results are shown in a case that the light portion potential VL is set to −100V with stronger exposure amount than ‘a’ row and the primary transfer contrast is 450V. In Y, M, and C, the primary transfer malfunction is the rank B and the pre-transfer is the rank C. On the other hand, about K, the primary transfer malfunction is the rank A as well as ‘a’ and the pre-transfer is the rank B as better than ‘a’. According to these results, the more proper primary transfer is obtained by adjusting exposure amount of the laser as the light portion potential VL of Y, M, and C is −150V and the light portion potential VL of K is −100V for 350V primary transfer voltage.

In the embodiment 2, usage condition of toner is shown by a number of printed sheets as well. A CPU 276 controls the primary transfer voltage to decrease and the exposure amount to increase as the number of printed sheets increases. The CPU 276 controls the primary transfer voltage corresponding to the number of printed sheets (for example 0) of a predetermined cartridge (for example Y, M, or C) that is with one of the least number of printed sheets out of multiple cartridges. The CPU 276 controls the exposure amount corresponding to the number of printed sheets (for example 5000 sheets) of the other cartridge that is different from the predetermined cartridge for the other cartridge (for example, K).

FIG. 11, part (b), is a graph showing relation between the number of printed sheets and the most proper primary transfer contrast. In FIG. 11, part (b) a horizontal axis shows the number of printing (sheets) and a vertical axis shows the primary transfer contrast. As the number of printed sheets increases, the most proper primary transfer contrast tends to decrease. As described in the embodiment 1, the primary transfer voltage is set corresponding to the color cartridge that is with the least number of printed sheets. Therefore, the exposure amount may be set within a range of maximum light quantity to obtain the primary transfer contrast in FIG. 11, part (b), with respect to the predetermined primary transfer voltage for the other color cartridges.

### (The Primary Transfer Voltage and the Determination Process of the Exposure Amount)

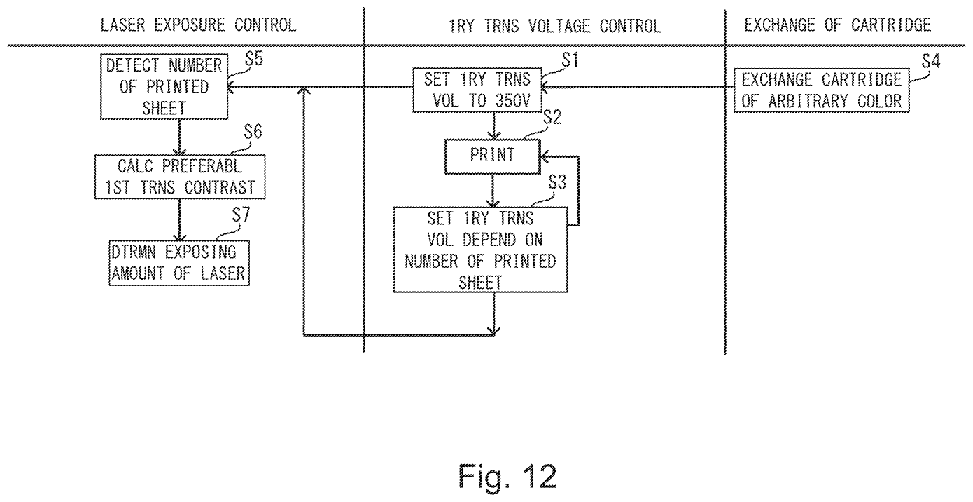

FIG. 12 is a chart showing a controlling process described above as a flowchart. FIG. 12 is chart that a row of a laser exposing control is added to FIG. 6. Therefore, the explanation of process in S1, S2, and S3 of the primary transfer voltage control and S4 of an operation of replacing cartridge are omitted. In the flowchart in FIG. 12, after the primary transfer voltage is determined either in S1 or S3, a process of S5, S6, and S7 is executed and determined the exposure amount for the cartridges except the cartridge with the least number of printed sheets. For more detail, as proceeding to S2 after S1, the CPU 276 executes a process of S5 of the laser exposing control as well. Also, as proceeding to S3 after S2 and proceeding back to S2 after S3, the CPU 276 executes the process of S5.

In the S5, the CPU 276 detects the number of printed sheets in a timing when the primary transfer voltage is determined. Note that, the CPU 276 is regarded as counting the printed sheets as described above. In S6, the CPU 276 determines the proper primary transfer contrast for the number of printed sheets detected in S5. For example, based on the relation in part (b) of FIG. 11, the CPU 276 may determine the primary transfer contrast. In S6, based on the primary transfer voltage that the proper primary transfer contrast is determined in S8, the CPU 276 determines the laser exposing amount to obtain the proper light portion potential VL.

As described above, in the embodiment 2, each image forming portion a, b, c, or d obtains the proper primary transfer contrast in the image forming apparatus as same as the embodiment 1. In the embodiment 2, the method that adjusts the laser exposing amount and finely adjusts the light portion potential VL based on the predetermined primary transfer voltage.

It was described in the embodiment 2 that the primary transfer contrast for the number of printed sheets in all image forming portions a, b, c, and d have the same tendency. However, in a case that each image forming portion a, b, c, or d has the different proper primary transfer contrast, the laser exposing amount may be determined as the light portion potential VL corresponding to each image forming portion. Also, though the controlling process to determine the laser exposing amount after the primary transfer voltage is determined is described in the embodiment 2, it is not limited to this process but the primary transfer voltage may be determined after the laser exposing amount is determined. Further, the description in the embodiment 2 is effective to the image forming apparatus with the rotary system shown in FIG. 8 and the same effect is expected as the embodiment 1 especially in a case that the same primary transfer voltage is applied to each image forming portion. Furthermore, in a case that different primary transfer voltage is set to each image forming portion, the more proper primary transfer contrast is set by slightly adjusting the laser exposing amount even when an enough setting range of the primary transfer voltage is not set, for example.

As described above, according to the embodiment 2, it is possible that the excellent primary transfer performance is obtained in the image forming apparatus with the intermediary transfer belt including the inner surface of low resistance layer as well.

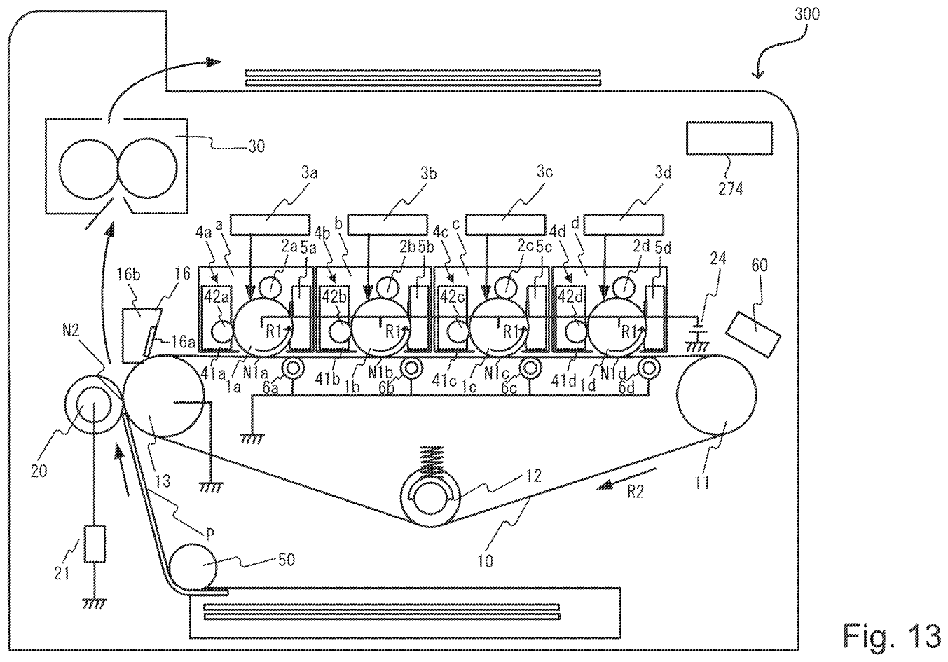

In an embodiment 3, a method to form the primary transfer contrast by applying a voltage to the photosensitive drum will be described. FIG. 13 is a cross-sectional schematic view showing a structure of an image forming apparatus 300 in the embodiment 3. Compared with the image forming apparatus 100 described in FIG. 1, it is characterized that a drum power resource 24 is provided which is a negative power source shared with photosensitive drums 1a, 1b, 1c, and 1d instead that the primary transfer rollers 6a, 6b, 6c, and 6d are grounded without the primary transfer power source 23. The drum power resource 24 functions as a secondary applying means applies a voltage to the photosensitive drums 1a, 1b, 1c, and 1d. The drum power source 24 is connected to apply a voltage (hereinafter, referred as a drum charge) to a bear pipe of each photosensitive drum 1a, 1b, 1c, or 1d. A CPU 276 in the embodiment 3 controls to apply a voltage to the photosensitive drum 1 by the drum power source 24 and controls a primary transfer contrast by controlling a surface potential of the photosensitive drum 1. Other processes except forming the primary transfer contrast by the drum charge are the same as the embodiment 1 and the embodiment 2. In the same structure as the structure described in FIG. 1, the same reference numerals are given and descriptions are omitted. The primary transfer contrast by applying the drum charge will be described below with the image forming portion a as an example.

### [Primary Transfer Contrast]

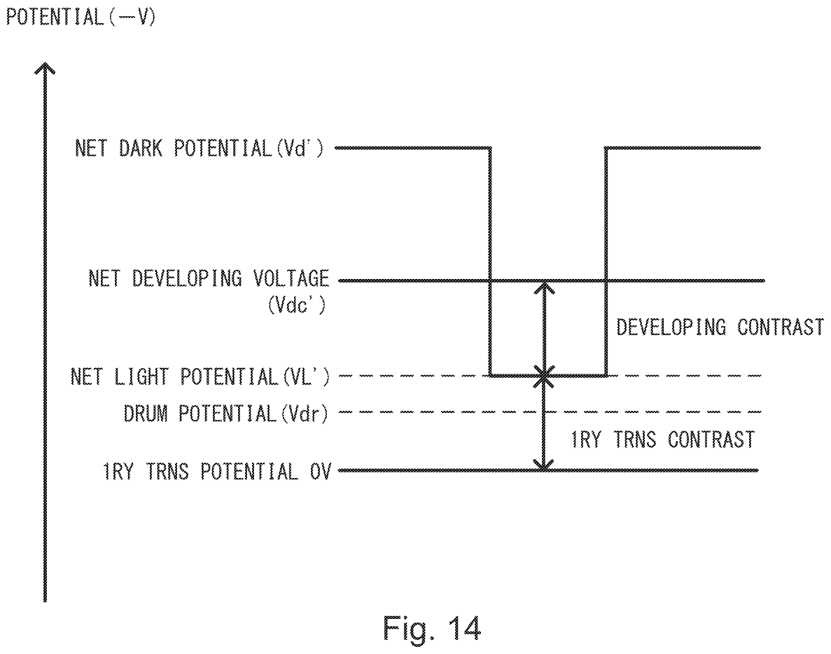

FIG. 14 is a schematic view to describe a relation between a primary transfer potential and the surface potential of the photosensitive drum 1a. FIG. 14 shows a drum base potential Vdr obtained by applying the drum voltage is formed. A net dark portion potential Vd′ or a net light portion potential VL′ is formed by that the surface potential of the photosensitive drum 1a is overlapped on the drum base potential Vdr. Both the net dark portion potential Vd′ and the net light portion potential VL′ are values added up the drum base potential Vdr and the dark portion potential Vd or the light portion potential VL when the drum base potential Vdr is 0V. Also, a net developing potential Vdc′ is a value added up the drum base potential Vdr and the developing potential Vdc when the drum base potential Vdr is 0V. In the embodiment 3, the primary transfer potential is 0V since the primary transfer roller 6a is grounded.

### (Evaluation of the Primary Transfer Malfunction and the Pre-Transfer)

The toner usage condition is indicated by the number of printed sheets in the embodiment 3 as well. The CPU 276 controls the surface potential of the photosensitive drum 1a to decrease as the number of printed sheets increases. A table 3 shows results of the evaluation of the primary transfer malfunction and the pre-transfer of the primary transfer contrast changed by adjusting the drum voltage in each number of the printed sheets. In the table 3, the results of evaluation in a condition which the light portion potential VL obtained by the laser exposing is fixed with −150V and the net light portion potential VL′ is changed by adjusting the drum potential Vdr is shown. Since the primary transfer potential is 0V, an absolute value of the net light portion potential VL′ is the primary transfer contrast. The results of evaluation of the same primary transfer contrast in FIG. 3 is same as FIG. 1.

TABLE 3

| First | | | First | Number of Printing sheet | | | | | | | | | | | |
|---|---|---|---|---|---|---|---|---|---|---|---|---|---|---|---|
| trans | | | trans | 0 | | 1000 | | 2000 | | 3000 | | 4000 | | 5000 | |
| voltge | Vdr | VL′ | cntrst | Trans | Pre- | Trans | Pre- | Trans | Pre- | Trans | Pre- | Trans | Pre- | Trans | Pre- |
| (V) | (−V) | (−V) | (V) | malfnct | trans | malfnct | trans | malfnct | trans | malfnct | trans | malfnct | tran | malfnct | trans |
| 0 | 100 | 250 | 250 | D | A | D | A | D | A | D | A | B | A | B | A |
| 0 | 150 | 300 | 300 | D | A | B | A | B | A | B | A | B | A | A | A |
| 0 | 200 | 350 | 350 | D | A | B | A | B | A | A | A | A | A | A | B |
| 0 | 250 | 400 | 400 | D | A | B | A | A | A | A | B | A | B | A | B |
| 0 | 300 | 450 | 450 | B | A | A | A | A | B | A | B | A | B | A | B |
| 0 | 350 | 500 | 500 | A | A | A | B | A | C | A | C | A | C | A | C |
| 0 | 400 | 550 | 550 | A | B | A | C | A | C | A | C | A | C | A | C |
| 0 | 450 | 600 | 600 | A | C | A | C | A | C | A | C | A | D | A | D |
| 0 | 500 | 650 | 650 | A | C | A | D | A | D | A | D | A | D | A | D |

The table 3 shows the primary transfer voltage (V) in a first column, the drum potential (−V) the net light portion potential VL′ (−V) in a third column, and the primary transfer contrast (V) in a fourth column. A fifth column in the table 1 shows the number of printed sheets (printing number) and transfer malfunction and the rank (A, B, C, and D) of pre-transfer as printing 0 sheet, 1000 sheets, 2000 sheets, 3000 sheets, 4000 sheets, and 5000 sheets.

### (Evaluation Result of Primary Transfer Malfunction)

Next, a result of primary transfer malfunction will be described with the Table 3.

### (Check Result of Primary Transfer Malfunction in 0 Printing Sheet)

In the table 3, in the case of printing in the state that the number of printing sheet is almost 0, the result is rank A in printing with 350V or larger absolute value of the drum potential. The result is rank B in printing with 300V drum potential. The result is rank D in printing with 250V or less drum potential.

### (Check Result of Primary Transfer Malfunction in 1000 Printed Sheets)

In the case of printing in the state that the number of printing sheet is almost 1000, the result is rank A in printing with 300V or larger absolute value of the drum potential. The result is rank B in printing with 150V, 200V, and 250V drum potential. The result is rank D in printing with 100V drum potential.

### (Check Result of Primary Transfer Malfunction in 2000 Printed Sheets)

In the case of printing in the state that the number of printing sheet is almost 2000, the result is rank A in printing with 250V or larger absolute value of drum potential. The result is rank B in printing with 150V and 200V drum potential. The result is rank D in printing with 100V drum potential.

### (Check Result of Primary Transfer Malfunction in 3000 Printed Sheets)

In the case of printing in the state that the number of printing sheet is almost 3000, the result is rank A in printing with 200V or larger absolute value of the drum potential. The result is rank B in printing with 150V drum potential. The result is rank D in printing with 100V drum potential.

### (Check Result of Primary Transfer Malfunction in 4000 Printed Sheets)

In the case of printing in the state that the number of printing sheet is almost 4000, the result is rank A in printing with 200V or larger primary transfer voltage. The result is rank B in printing with 100V and 150V primary transfer voltage.

### (Check Result of Primary Transfer Malfunction in 5000 Printed Sheets)

In the case of printing in the state that the number of printing sheet is almost 5000, the result is rank A in printing with 150V or larger absolute value of drum potential. The result is rank B in printing with 100V drum potential.

The results in the table 3 show that the absolute value of the drum potential with which the primary transfer malfunction occurs tends to be lower as the number of printed sheets increasing. In the case of printing in the state that the number of printing sheet is almost 5000, the primary transfer malfunction is not spotted on the image even with 100V absolute value of the drum potential in the results.

### (Evaluation Result of Pre-Transfer)

Next, a tendency of pre-transfer will be described.

### (Checked Result of Pre-Transfer in 0 Printing Sheet)

In the table 3, in the case of printing in the state that the number of printing sheet is almost 0, the result is rank A in printing with 350V or less absolute value of the drum potential. The result is rank B in printing with 400V drum potential. The result is rank C in printing with 450V or larger drum potential.

### (Check Result of Primary Transfer Malfunction in 1000 Printed Sheets)

Next, in the case of printing in the state that the number of printing sheet is almost 1000, the result is rank A in printing with 300V or less absolute value of the drum potential. The result is rank B in printing with 350V drum potential. The result is rank C in printing with 400V and 450V drum potential. The result is rank D in printing with 500V or larger drum potential.

### (Check Result of Primary Transfer Malfunction in 2000 Printed Sheets)

Next, in the case of printing in the state that the number of printing sheet is almost 2000, the result is rank A in printing with 250V or less absolute value of the drum potential. The result is rank B in printing with 300V drum potential. The result is rank C in printing with 350V, 400V and 450V drum potential. The result is rank D in printing with 500V or larger drum potential.

### (Check Result of Primary Transfer Malfunction in 3000 Printed Sheets)

Next, in the case of printing in the state that the number of printing sheet is almost 3000, the result is rank A in printing with 200V or less absolute value of the drum potential. The result is rank B in printing with 250V and 300V drum potential. The result is rank C in printing with 350V, 400V, and 450V drum potential. The result is rank D in printing with 500V or larger drum potential.

### (Check Result of Primary Transfer Malfunction in 4000 Printed Sheets)

Next, in the case of printing in the state that the number of printing sheet is almost 4000, the result is rank A in printing with 200V or less absolute value of the drum potential. The result is rank B in printing with 250V and 300V drum potential. The result is rank C in printing with 350V and 400V drum potential. The result is rank D in printing with 450V or larger drum potential.

### (Check Result of Primary Transfer Malfunction in 5000 Printed Sheets)

Next, in the case of printing in the state that the number of printing sheet is almost 5000, the result is rank A in printing with 150V or less absolute value of the drum potential. The result is rank B in printing with 200V, 250V, and 300V drum potential. The result is rank C in printing with 350V and 400V drum potential. The result is rank D in printing with 450V or larger drum potential.

The results above show that the absolute value of the drum potential with which the pre-transfer occurs tends to be lower as the number of printed sheets increasing.

### (Process Determination of the Primary Transfer Voltage and the Drum Voltage)

It is possible that FIG. 12 is cited to the process determination of the primary transfer voltage and the drum voltage in the embodiment 3. In FIG. 12, the laser exposing control shown in the left side is referred to as a drum potential control. Further, the CPU 276 may determine the drum potential Vdr in S9 as the primary transfer contrast obtained in S8 after the primary transfer contrast corresponding to the number of printed sheets is obtained in S8 based on FIG. 11, part (b). Also, the CPU 276 may control the drum power source 24 to apply the drum voltage.

In the embodiment 3, though the method adjusting the drum voltage as an adjusting means for the primary transfer contrast in the image forming apparatus 300 with a tandem system shown in FIG. 9 is described, the same adjustment is possible in the rotary system. Also, in the embodiment 3, though the state that the primary transfer voltage is grounded is described, it is not necessary to be grounded. Further, it is possible that the drum voltage adjusts the primary transfer contrast by connecting Zener diode, for example, to generate a fixed voltage. Also, it is possible for both the primary transfer voltage and the drum voltage to adjust the primary transfer contrast as well.

As described above, according to the embodiment 3, it is possible that the excellent primary transfer performance is obtained in the image forming apparatus with the intermediary transfer belt including the inner surface of low resistance layer as well.

According to the present invention, it is possible that the excellent primary transfer performance is obtained in the image forming apparatus with the intermediary transfer belt including the inner surface of low resistance layer as well.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-037940 filed Mar. 11, 2022, which is hereby incorporated by reference herein in its entirety.

What is claimed is:

1. An image forming apparatus for forming an image on a recording material, the image forming apparatus comprising:
a photosensitive member;
a charging member configured to charge the photosensitive member;
an exposing unit configured to form an electrostatic latent image by exposing the photosensitive member depending on an image signal;
a developing member configured to form a toner image by developing the electrostatic laten image with the toner;
an intermediary transfer member provided with a first layer having conductivity and a second layer having conductivity and a lower resistance value than that of the second layer, and to which the toner image is transferred in a nip portion between itself and the photosensitive member;
a voltage applying portion configured to apply a transfer voltage to the intermediary transfer member; and
a control portion configured to control a primary transfer contrast which is a difference between the transfer voltage applied by the voltage applying portion in the nip portion and a potential of a part exposed by the exposing unit on the photosensitive member,
wherein, by applying the transfer voltage to the intermediary transfer member from the voltage applying portion, the control portion transfers the toner image from the photosensitive member to the intermediary transfer member by flowing a current in a circumferential direction,
wherein the control portion controls the primary transfer contrast by controlling the transfer voltage based on information on a usage state of the toner related to a number of printed sheets of the recording material, and
wherein the control portion controls so that the transfer voltage becomes lower as the number of printed sheets is larger.

2. An image forming apparatus according to claim 1, wherein the control portion controls so that the transfer voltage becomes linearly lower from an initial value of the transfer voltage at a time when the number of printed sheets is zero as the number of printed sheets increases until the number of printed sheets becomes a predetermined number, and so as to maintain the transfer voltage at a constant value after the number of printed sheets reaches the predetermined number.

3. An image forming apparatus according to claim 2, further comprising a plurality of exchangeable cartridges each including an accommodating portion configured to accommodate the toner and at least the photosensitive member and the developing member,
wherein when the cartridge is exchanged, the control portion restores the transfer voltage to the initial value regardless of the number of printed sheets, and controls the transfer voltage based on the number of printed sheets after restoring the number of printed sheets.

4. An image forming apparatus according to claim 1, wherein the control portion controls the primary transfer contrast by controlling a surface potential of the photosensitive member.

5. An image forming apparatus according to claim 4, wherein the control portion controls the surface potential of the photosensitive member by controlling an exposure amount with which the surface of the photosensitive member is exposed by the exposing unit.

6. An image forming apparatus according to claim 5, wherein the control portion increases the exposure amount as the number of printed sheets is larger.

7. An image forming apparatus according to claim 6, further comprising a plurality of exchangeable cartridges each including an accommodating portion configured to accommodate the toner and at least the photosensitive member and the developing member,
wherein the control portion controls the transfer voltage based on a number of printed sheets of a first cartridge of which the number of printed sheets is minimum among the plurality of cartridges, and controls the exposure amount of a second cartridge of which the number of printed sheets is different from that of the first cartridge based on the number of printed sheets of the second cartridge.

8. An image forming apparatus according to claim 1, wherein the information on the usage state of the toner is represented by an accumulated revolution number of the developing member, and
wherein the control portion controls the primary transfer contrast based on the accumulated revolution number.

9. An image forming apparatus according to claim 1, wherein the information on the usage state of the toner is represented by a consumption of the toner, and
wherein the control portion controls the primary transfer contrast based on the consumption of the toner.

10. An image forming apparatus for forming an image on a recording material, the image forming apparatus comprising:
a photosensitive member;
a charging member configured to charge the photosensitive member;
an exposing unit configured to form an electrostatic laten image by exposing the photosensitive member depending on an image signal;
a rotary provided with a plurality of developing devices each including a developing member configured to form a toner image by developing the electrostatic laten image with the toner by contacting the photosensitive member and an accommodating portion configured to accommodate the toner, and configured to be capable of switching the developing member to be contacted to the photosensitive member by rotating;
an intermediary transfer member provided with a first layer having conductivity and a second layer having conductivity and a lower resistance value than that of the second layer, and to which the toner image is transferred in a nip portion between itself and the photosensitive member;
a voltage applying portion configured to apply a transfer voltage to the intermediary transfer member; and
a control portion configured to control a primary transfer contrast which is a difference between the transfer voltage applied by the voltage applying portion in the nip portion and a potential of a part exposed by the exposing unit on the photosensitive member,
wherein, by applying the transfer voltage to the intermediary transfer member from the voltage applying portion, the control portion transfers the toner image from the photosensitive member to the intermediary transfer member by flowing a current in a circumferential direction,
wherein the control portion controls the primary transfer contrast by controlling the transfer voltage based on information on a usage state of the toner related to a number of printed sheets of the recording material, and
wherein the control portion controls so that the transfer voltage becomes lower as the number of printed sheets is larger.

11. An image forming apparatus according to claim 10, wherein the control portion controls so that the transfer voltage becomes linearly lower from an initial value of the transfer voltage at a time when the number of printed sheets is zero as the number of printed sheets increases until the number of printed sheets becomes a predetermined number, and so as to maintain the transfer voltage at a constant value after the number of printed sheets reaches the predetermined number.

12. An image forming apparatus according to claim 11 wherein the control portion controls the transfer voltage every time the developing device is switched.

13. An image forming apparatus according to claim 12, wherein when the developing device is exchanged, the control portion restores the transfer voltage to the initial value regardless of the number of printed sheets, and controls the transfer voltage based on the number of printed sheets after restoring the number of printed sheets.
